(19) United States
(12) Patent Application Publication
(10) Pub. No.: US 2024/0380513 A1
(43) Pub. Date: Nov. 14, 2024

(54) DETERMINING A NUMBER OF PRBS FOR A PUCCH TRANSMISSION

(71) Applicant: Lenovo (Singapore) Pte. Ltd., New Tech Park (SG)

(72) Inventors: Hyejung Jung, Northbrook, IL (US); Vijay Nangia, Woodridge, IL (US); Hossein Bagheri, Urbana, IL (US)

(21) Appl. No.: 18/559,174

(22) PCT Filed: May 5, 2022
(86) PCT No.: PCT/IB2022/054171

§ 371 Date: Nov. 6, 2023

Related U.S. Application Data
(60) Provisional application No. 63/184,624, filed on May 5, 2021.

(51) Int. Cl. H04L 1/00; H04W 72/21; H04W 72/566

(52) U.S. Cl. CPC H04L 1/0013; H04W 72/21; H04W 72/566

(57) ABSTRACT

Apparatuses, methods, and systems are disclosed for determining a number of PRBs for a PUCCH transmission. One method includes receiving information indicating a first code rate and a second code rate. The first code rate is associated with multiplexed HP UCI bits and the second code rate is associated with multiplexed LP UCI bits. The method includes determining a number of PRBs for a PUCCH transmission based at least on the first code rate, a number of multiplexed HP UCI bits, the second code rate, a number of multiplexed LP UCI bits, and a maximum number of PRBs for the PUCCH transmission. The method includes transmitting the PUCCH transmission in the number of PRBs.

### CROSS-REFERENCE TO RELATED APPLICATIONS

This application claims priority to U.S. Patent Application Ser. No. 63/184,624 entitled “APPARATUSES, METHODS, AND SYSTEMS FOR REPORTING OF MIXED PRIORITY UPLINK CONTROL INFORMATION IN PHYSICAL UPLINK CONTROL CHANNEL” and filed on May 5, 2021 for Hyejung Jung et al., which is incorporated herein by reference in its entirety.

### FIELD

The subject matter disclosed herein relates generally to wireless communications and more particularly relates to determining a number of PRBs for a PUCCH transmission.

### BACKGROUND

In certain wireless communications networks, uplink control information that has mixed priority may need to be transmitted in a same physical uplink channel. In such networks, it may be necessary to multiplex the uplink control information with the mixed priority efficiently.

### BRIEF SUMMARY

Methods for determining a number of PRBs for a PUCCH transmission are disclosed. Apparatuses and systems also perform the functions of the methods. One embodiment of a method includes receiving, at a UE, information indicating a first code rate and a second code rate. The first code rate is associated with multiplexed HP UCI bits and the second code rate is associated with multiplexed LP UCI bits. In some embodiments, the method includes determining a number of PRBs for a PUCCH transmission based at least on the first code rate, a number of multiplexed HP UCI bits, the second code rate, a number of multiplexed LP UCI bits, and a maximum number of PRBs for the PUCCH transmission. In certain embodiments, the method includes transmitting the PUCCH transmission in the number of PRBs.

One apparatus for determining a number of PRBs for a PUCCH transmission includes a user equipment. In some embodiments, the apparatus includes a receiver to receive information indicating a first code rate and a second code rate. The first code rate is associated with multiplexed HP UCI bits and the second code rate is associated with multiplexed LP UCI bits. In various embodiments, the apparatus includes a processor to determine a number of PRBs for a PUCCH transmission based at least on the first code rate, a number of multiplexed HP UCI bits, the second code rate, a number of multiplexed LP UCI bits, and a maximum number of PRBs for the PUCCH transmission. In certain embodiments, the apparatus includes a transmitter to transmit the PUCCH transmission in the number of PRBs.

Another embodiment of a method for determining a number of PRBs for a PUCCH transmission includes transmitting, from a network device, information indicating a first code rate and a second code rate. The first code rate is associated with multiplexed HP UCI bits and the second code rate is associated with multiplexed LP UCI bits. In some embodiments, the method includes receiving a PUCCH transmission in a number of PRBs. The number of PRBs determined for the PUCCH transmission is based at least on the first code rate, a number of multiplexed HP UCI bits, the second code rate, a number of multiplexed LP UCI bits, and a maximum number of PRBs for the PUCCH transmission.

Another apparatus for determining a number of PRBs for a PUCCH transmission includes a user equipment. In some embodiments, the apparatus includes a transmitter to transmit information indicating a first code rate and a second code rate. The first code rate is associated with multiplexed HP UCI bits and the second code rate is associated with multiplexed LP UCI bits. In various embodiments, the apparatus includes a receiver to receive a PUCCH transmission in a number of PRBs. The number of PRBs determined for the PUCCH transmission is based at least on the first code rate, a number of multiplexed HP UCI bits, the second code rate, a number of multiplexed LP UCI bits, and a maximum number of PRBs for the PUCCH transmission.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for determining a number of PRBs for a PUCCH transmission;

FIG. 2 is a schematic block diagram illustrating one embodiment of an apparatus that may be used for determining a number of PRBs for a PUCCH transmission:

FIG. 3 is a schematic block diagram illustrating one embodiment of an apparatus that may be used for determining a number of PRBs for a PUCCH transmission:

FIG. 4 is a schematic block diagram illustrating one embodiment of a system for determining a number of PRBs for a PUCCH transmission:

FIG. 5 is a flow chart diagram illustrating one embodiment of a method for determining a number of PRBs for a PUCCH transmission; and

FIG. 6 is a flow chart diagram illustrating another embodiment of a method for determining a number of PRBs for a PUCCH transmission.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including.” “comprising.” “having.” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

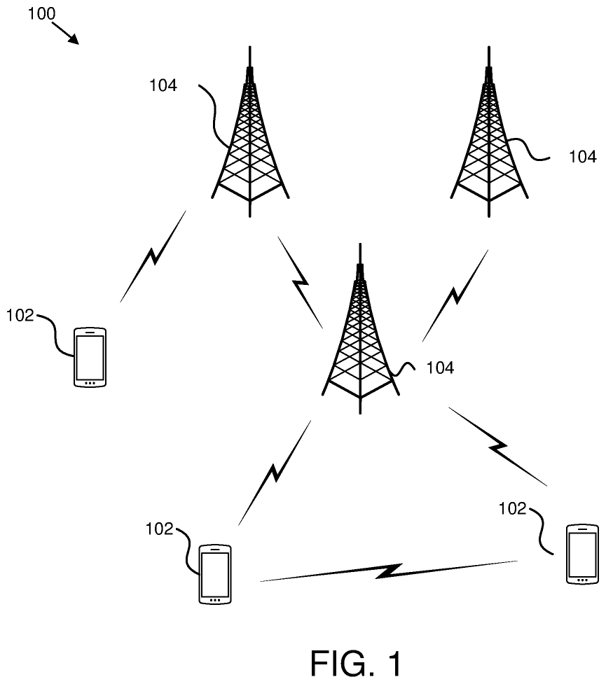

FIG. 1 depicts an embodiment of a wireless communication system 100 for determining a number of PRBs for a PUCCH transmission. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth R, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive information indicating a first code rate and a second code rate. The first code rate is associated with multiplexed HP UCI bits and the second code rate is associated with multiplexed LP UCI bits. In some embodiments, the remote unit 102 may determine a number of PRBs for a PUCCH transmission based at least on the first code rate, a number of multiplexed HP UCI bits, the second code rate, a number of multiplexed LP UCI bits, and a maximum number of PRBs for the PUCCH transmission. In certain embodiments, the remote unit 102 may transmit the PUCCH transmission in the number of PRBs. Accordingly, the remote unit 102 may be used for determining a number of PRBs for a PUCCH transmission.

In certain embodiments, a network unit 104 may transmit information indicating a first code rate and a second code rate. The first code rate is associated with multiplexed HP UCI bits and the second code rate is associated with multiplexed LP UCI bits. In some embodiments, the network unit 104 may receive a PUCCH transmission in a number of PRBs. The number of PRBs determined for the PUCCH transmission is based at least on the first code rate, a number of multiplexed HP UCI bits, the second code rate, a number of multiplexed LP UCI bits, and a maximum number of PRBs for the PUCCH transmission. Accordingly, the network unit 104 may be used for determining a number of PRBs for a PUCCH transmission.

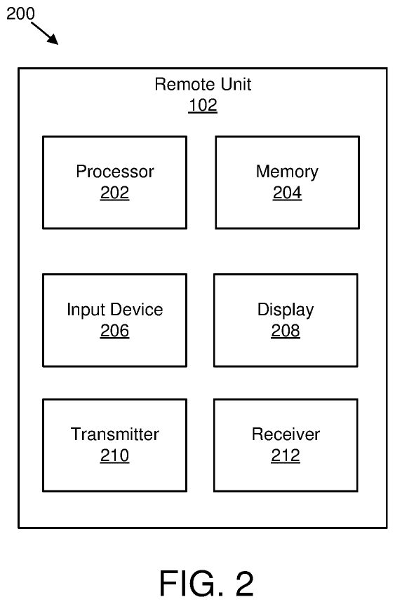

FIG. 2 depicts one embodiment of an apparatus 200 that may be used for determining a number of PRBs for a PUCCH transmission. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the receiver 212 may receive information indicating a first code rate and a second code rate. The first code rate is associated with multiplexed HP UCI bits and the second code rate is associated with multiplexed LP UCI bits. In various embodiments, the processor 202 may determine a number of PRBs for a PUCCH transmission based at least on the first code rate, a number of multiplexed HP UCI bits, the second code rate, a number of multiplexed LP UCI bits, and a maximum number of PRBs for the PUCCH transmission. In certain embodiments, the transmitter 210 may transmit the PUCCH transmission in the number of PRBs.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

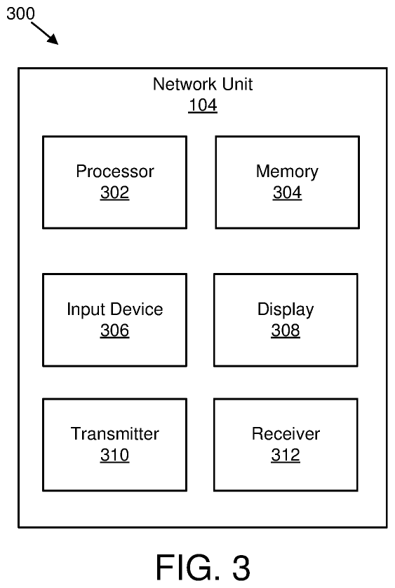

FIG. 3 depicts one embodiment of an apparatus 300 that may be used for determining a number of PRBs for a PUCCH transmission. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the transmitter 310 may transmit information indicating a first code rate and a second code rate. The first code rate is associated with multiplexed HP UCI bits and the second code rate is associated with multiplexed LP UCI bits. In various embodiments, the receiver 312 may receive a PUCCH transmission in a number of PRBs. The number of PRBs determined for the PUCCH transmission is based at least on the first code rate, a number of multiplexed HP UCI bits, the second code rate, a number of multiplexed LP UCI bits, and a maximum number of PRBs for the PUCCH transmission.

It should be noted that one or more embodiments described herein may be combined into a single embodiment.

In certain embodiments, such as in 3GPP new radio (“NR”), a user equipment (“UE”) may be configured to generate two hybrid automatic repeat request (“HARQ”) acknowledgement (“ACK”) (“HARQ-ACK”) codebooks, one associated with a high priority physical uplink control channel (“PUCCH”) and the other associated with a low priority PUCCH, If the UE would transmit a PUCCH or physical uplink shared channel (“PUSCH”) of a higher priority index that fully or partially overlaps (e.g., in time domain) with transmission of a PUCCH or PUSCH of a lower priority index, the UE cancels the transmission of the PUCCH or PUSCH of the lower priority index.

In some embodiments, such as for NR, multiplexing of low priority (“LP”) HARQ-ACK information with high priority (“HP”) uplink control information (“UCI”) in a PUCCH or a PUSCH may be made. For multiplexing a HP HARQ-ACK and a LP HARQ-ACK into a PUCCH, when the total number of LP and HP HARQ-ACK bits is more than 2, separate coding for the two HARQ-ACKs may be supported. For multiplexing a HP HARQ-ACK and a LP HARQ-ACK into a PUSCH, separate coding for the two HARQ-ACKs may be supported.

In various embodiments, there may be methods to handle HP channel state information (“CSI”) reports that a UE would transmit on a PUCCH of a higher physical layer priority index, to determine a number of physical resource blocks (“PRBs”) for a PUCCH carrying LP and HP UCI bits, and to multiplex separately encoded LP UCI and HP UCI bits and map them to resource elements of the PUCCH.

In certain embodiments, a PUSCH or a PUCCH transmission, including repetitions if any, may be of priority index 0 or of priority index 1. For a configured grant PUSCH transmission, a UE determines a priority index from priority, if provided. For a PUCCH transmission with HARQ-ACK information corresponding to a semi-persistent scheduling (“SPS”) physical downlink shared channel (“PDSCH”) reception or a SPS PDSCH release, a UE determines a priority index from harq-CodebookID), if provided. For a PUCCH transmission with SR, a UE determines the corresponding priority. For a PUSCH transmission with semi-persistent CSI report, a UE determines a priority index from a priority indicator field, if provided, in a DCI format 0_1 or DCI format 0_2 that activates the semi-persistent CSI report. If a priority index is not provided to a UE for a PUSCH or a PUCCH transmission, the priority index is 0.

If a UE is provided two PUCCH-Config: 1) if the UE is provided subslotLengthForPUCCH-r16 in the first PUCCH-Config, the PUCCH resource for any SR configuration with priority index 0 or any CSI report configuration in any PUCCH-Config is within the subslotLengthForPUCCH-r16 symbols in the first PUCCH-Config; and/or 2) if the UE is provided subslotlengthForPUCCH-r16 in the second PUCCH-Config, the PUCCH resource for any SR configuration with priority index 1 in any PUCCH-Config is within the subslotLengthForPUCCH-r16 symbols in the second PUCCH-Config.

If in an active DL bandwidth part (“BWP”) a UE monitors physical downlink control channel (“PDCCH”) either for detection of DCI format 0_1 and DCI format 1_1 or for detection of DCI format 0_2 and DCI format 1_2, a priority index can be provided by a priority indicator field. If a UE indicates a capability to monitor, in an active DL BWP, PDCCH for detection of DCI format 0_1 and DCI format 1_1 and for detection of DCI format 0_2 and DCI format 1_2, a DCI format 0_1 or a DCI format 0_2 can schedule a PUSCH transmission of any priority and a DCI format 1_1 or a DCI format 1_2 can schedule a PDSCH reception and trigger a PUCCH transmission with corresponding HARQ-ACK information of any priority.

When a UE determines overlapping for PUCCH and/or PUSCH transmissions of different priority indexes, the UE first resolves the overlapping for PUCCH and/or PUSCH transmissions of smaller priority index. Then: 1) if a transmission of a first PUCCH of larger priority index scheduled by a DCI format in a PDCCH reception would overlap in time with a transmission of a second PUSCH or a second PUCCH of smaller priority index, the UE cancels the transmission of the second PUSCH or the second PUCCH before the first symbol that would overlap with the first PUCCH transmission: 2) if a transmission of a first PUSCH of larger priority index scheduled by a DCI format in a PDCCH reception would overlap in time with a transmission of a second PUCCH of smaller priority index, the UE cancels the transmission of the second PUCCH before the first symbol that would overlap with the first PUSCH transmission; where: the overlapping is applicable before or after resolving overlapping among channels of larger priority index, if any, the UE expects that the transmission of the first PUCCH or the first PUSCH, respectively, would not start before T_{proc,2}+d₁ after a last symbol of the corresponding PDCCH reception, and T_{proc,2} is the PUSCH preparation time for a corresponding UE processing capability assuming d_{2,1}=0, based on u and N₂ as subsequently defined in this Clause, and d₁ is determined by a reported UE capability.

If a UE is scheduled by a DCI format in a first PDCCH reception to transmit a first PUCCH or a first PUSCH of larger priority index that overlaps with a second PUCCH or a second PUSCH transmission of smaller priority index that, if any, is scheduled by a DCI format in a second PDCCH T_{proc,2} is based on a value of u corresponding to the smallest subcarrier spacing (“SCS”) configuration of the first PDCCH, the second PDCCHs, the first PUCCH or the first PUSCH, and the second PUCCHs or the second PUSCHs: 1) if the overlapping group includes the first PUCCH, if processingType2Enabled of PDSCH-ServingCellConfig is set to enable for the serving cell where the UE receives the first PDCCH and for all serving cells where the UE receives the PDSCHs corresponding to the second PUCCHs, and if processingType2Enabled of PUSCH-ServingCellConfig is set to enable for the serving cells with the second PUSCHs, N₂ is 5 for u=0, 5.5 for μ=1 and 11 for μ=2, else, N₂ is 10 for μ=0, 12 for μ=1, 23 for μ=2, and 36 for p=3; and 2) if the overlapping group includes the first PUSCH, and if processingType2Enabled of PUSCH-ServingCellConfig is set to enable for the serving cells with the first PUSCH and the second PUSCHs and if processingType2Enabled of PDSCH-ServingCellConfig is set to enable for all serving cells where the UE receives the PDSCHs corresponding to the second PUCCHs, N₂ is 5 for μ=0, 5.5 for μ=1 and 11 for μ=2 else, N₂ is 10 for μ=0, 12 for μ=1, 23 for μ=2, and 36 for μ=3.

If a UE would transmit the following channels that would overlap in time: 1) a first PUCCH of larger priority index with SR and a second PUCCH or PUSCH of smaller priority index: or 2) a configured grant PUSCH of larger priority index and a PUCCH of smaller priority index: or 3) a first PUCCH of larger priority index with HARQ-ACK information only in response to a PDSCH reception without a corresponding PDCCH and a second PUCCH of smaller priority index with SR and/or CSI, or a configured grant PUSCH with smaller priority index, or a PUSCH of smaller priority index with semi-persistent (“SP”) CSI (“SP-CSI”) report(s) without a corresponding PDCCH: or 4) a PUSCH of larger priority index with SP-CSI reports(s) without a corresponding PDCCH and a PUCCH of smaller priority index with SR, or CSI, or HARQ-ACK information only in response to a PDSCH reception without a corresponding PDCCH: or 5) a configured grant PUSCH of larger priority index and a configured PUSCH of lower priority index on a same serving cell.

The UE is expected to cancel the PUCCH/PUSCH transmissions of smaller priority index before the first symbol overlapping with the PUCCH/PUSCH transmission of larger priority index. A UE does not expect to be scheduled to transmit a PUCCH or a PUSCH with smaller priority index that would overlap in time with a PUCCH of larger priority index with HARQ-ACK information only in response to a PDSCH reception without a corresponding PDCCH. A UE does not expect to be scheduled to transmit a PUCCH of smaller priority index that would overlap in time with a PUSCH of larger priority index with SP-CSI report(s) without a corresponding PDCCH.

In various embodiments, a UE multiplexes UCIs with a same priority index in a PUCCH or a PUSCH. A PUCCH or a PUSCH is assumed to have a same priority index as a priority index of UCIs a UE multiplexes in the PUCCH or the PUSCH.

In certain embodiments, if a UE is provided subslotLengthForPUCCH-r16, a slot for an associated PUCCH transmission includes a number of symbols indicated by subslotLengthForPUCCH-r16.

If a UE would transmit on a serving cell a PUSCH without UL-SCH that overlaps with a PUCCH transmission on a serving cell that includes positive SR information, the UE does not transmit the PUSCH. If a UE would transmit CSI reports on overlapping physical channels, the UE applies the priority rules for the multiplexing of CSI reports. If a UE has overlapping resources for PUCCH transmissions in a slot and at least one of the PUCCH transmissions is with repetitions over multiple slots, the UE first follows procedures for resolving the overlapping among the resources for the PUCCH transmissions.

If a UE would multiplex UCI in a PUCCH transmission that overlaps with a PUSCH transmission and the PUSCH and PUCCH transmissions fulfill conditions for UCI multiplexing, the UE: 1) multiplexes only HARQ-ACK information, if any, from the UCI in the PUSCH transmission and does not transmit the PUCCH if the UE multiplexes aperiodic or semi-persistent CSI reports in the PUSCH; and 2) multiplexes only HARQ-ACK information and CSI reports, if any, from the UCI in the PUSCH transmission and does not transmit the PUCCH if the UE does not multiplex aperiodic or semi-persistent CSI reports in the PUSCH.

A UE does not expect to multiplex in a PUSCH transmission in one slot with SCS configuration IL UCI of same type that the UE would transmit in PUCCHs in different slots with SCS configuration 12 if A<14. Moreover, a UE does not expect to multiplex in a PUSCH transmission or in a PUCCH transmission HARQ-ACK information that the UE would transmit in different PUCCHs. A UE does not expect a PUCCH resource that results from multiplexing overlapped PUCCH resources, if applicable, to overlap with more than one PUSCHs if each of the more than one PUSCHs includes aperiodic CSI reports.

Further, a UE does not expect to detect a DCI format scheduling a PDSCH reception or a SPS PDSCH release, or a DCI format including a One-shot HARQ-ACK request field with value 1, and indicating a resource for a PUCCH transmission with corresponding HARQ-ACK information in a slot if the UE previously detects a DCI format scheduling a PUSCH transmission in the slot and if the UE multiplexes HARQ-ACK information in the PUSCH transmission.

If a UE multiplexes aperiodic CSI in a PUSCH and the UE would multiplex UCI that includes HARQ-ACK information in a PUCCH that overlaps with the PUSCH and the timing conditions for overlapping PUCCHs and PUSCHs are fulfilled, the UE multiplexes only the HARQ-ACK information in the PUSCH and does not transmit the PUCCH.

If a UE transmits multiple PUSCHs in a slot on respective serving cells that include first PUSCHs that are scheduled by DCI formats and second PUSCHs configured by respective ConfiguredGrantConfig or semiPersistentOnPUSCH, and the UE would multiplex UCI in one of the multiple PUSCHs, and the multiple PUSCHs fulfil the conditions for UCI multiplexing, the UE multiplexes the UCI in a PUSCH from the first PUSCHs.

If a UE transmits multiple PUSCHs in a slot on respective serving cells and the UE would multiplex UCI in one of the multiple PUSCHs and the UE does not multiplex aperiodic CSI in any of the multiple PUSCHs, the UE multiplexes the UCI in a PUSCH of the serving cell with the smallest ServCellIndex subject to the conditions for UCI multiplexing being fulfilled. If the UE transmits more than one PUSCHs in the slot on the serving cell with the smallest ServCellIndex that fulfil the conditions for UCI multiplexing, the UE multiplexes the UCI in the earliest PUSCH that the UE transmits in the slot.

If a UE transmits a PUSCH over multiple slots and the UE would transmit a PUCCH with HARQ-ACK and/or CSI information over a single slot that overlaps with the PUSCH transmission in one or more slots of the multiple slots, and the PUSCH transmission in the one or more slots fulfills the conditions for multiplexing the HARQ-ACK and/or CSI information, the UE multiplexes the HARQ-ACK and/or CSI information in the PUSCH transmission in the one or more slots. The UE does not multiplex HARQ-ACK and/or CSI information in the PUSCH transmission in a slot from the multiple slots if the UE would not transmit a single-slot PUCCH with HARQ-ACK and/or CSI information in the slot in case the PUSCH transmission was absent.

If a UE transmits a PUSCH with repetition Type B and the UE would transmit a PUCCH with HARQ-ACK and/or CSI information over a single slot that overlaps with the PUSCH transmission in one or more slots, the UE expects all actual repetitions of the PUSCH transmission that would overlap with the PUCCH transmission to fulfill the conditions for multiplexing the HARQ-ACK and/or CSI information, and the UE multiplexes the HARQ-ACK and/or CSI information in the earliest actual PUSCH repetition of the PUSCH transmission that would overlap with the PUCCH transmission and includes more than one symbol. The UE does not expect that all actual repetitions that would overlap with the PUCCH transmission do not include more than one symbol.

If the PUSCH transmission over the multiple slots is scheduled by a DCI format that includes a downlink assignment index (“DAI”) field, the value of the DAI field is applicable for multiplexing HARQ-ACK information in the PUSCH transmission in any slot from the multiple slots where the UE multiplexes HARQ-ACK information.

In various embodiments, if a UE is provided pdsch-HARQ-ACK-Codebook-List, the UE can be indicated by pdsch-HARQ-ACK-Codebook-List to generate one or two HARQ-ACK codebooks. If the UE is indicated to generate one HARQ-ACK codebook, the HARQ-ACK codebook is associated with a PUCCH of priority index 0. If a UE is provided pdsch-HARQ-ACK-Codebook-List, the UE multiplexes in a same HARQ-ACK codebook only HARQ-ACK information associated with a same priority index. If the UE is indicated to generate two HARQ-ACK codebooks: 1) a first HARQ-ACK codebook is associated with a PUCCH of priority index 0 and a second HARQ-ACK codebook is associated with a PUCCH of priority index 1; and 2) the UE is provided first and second for each of {PUCCH-Config, UCI-OnPUSCH, PDSCH-code Block GroupTransmission} by {PUCCHConfigurationList, UCI-OnPUSCH-List, PDSCH-CodeBlockGroupTransmission-List}, respectively, for use with the first and second HARQ-ACK codebooks, respectively.

If a UE receives a PDSCH without receiving a corresponding PDCCH, or if the UE receives a PDCCH indicating a SPS PDSCH release, the UE generates one corresponding HARQ-ACK information bit. If the UE generates two HARQ-ACK codebooks, the UE is indicated by harq-CodebookIl), per SPS PDSCH configuration, a HARQ-ACK codebook index for multiplexing the corresponding HARQ-ACK information bit.

If a UE is provided pdsch-HARQ-ACK-OneShotFeedback-r16 and the UE detects a DCI format in any PDCCH monitoring occasion that includes a One-shot HARQ-ACK request field with value 1:1) the UE includes the HARQ-ACK information in a Type-3 HARQ-ACK codebook; and 2) the UE does not expect that the PDSCH-to-HARQ_feedback timing indicator field of the DCI format provides an inapplicable value from dl-DataToUL-ACK.

In certain embodiments, reference is to one HARQ-ACK codebook and to DCI formats that schedule PDSCH reception, or indicate SPS PDSCH release, or indicate SCell dormancy without scheduling a PDSCH reception and are associated with the HARQ-ACK codebook.

If a UE is configured to receive SPS PDSCHs in a slot for SPS configurations that are indicated to be released by a DCI format, and if the UE receives the PDCCH providing the DCI format in the slot where the end of a last symbol of the PDCCH reception is not after the end of a last symbol of any of the SPS PDSCH receptions, and if HARQ-ACK information for the SPS PDSCH release and the SPS PDSCH receptions would be multiplexed in a same PUCCH, the UE does not expect to receive the SPS PDSCHs, does not generate HARQ-ACK information for the SPS PDSCH receptions, and generates a HARQ-ACK information bit for the SPS PDSCH release.

If a UE detects a DCI format 1_1 indicating SCell dormancy without scheduling a PDSCH reception, and is provided pdsch-HARQ-ACK-Codebook=dynamic or enhancedDynamic-r16, the UE generates a HARQ-ACK information bit for a DCI format 1_1 indicating SCell dormancy and the HARQ-ACK information bit value is ACK. If a UE is not provided PDSCH-CodeBlockGroupTransmission, the UE generates one HARQ-ACK information bit per transport block.

For a HARQ-ACK information bit, a UE generates a positive acknowledgement (“ACK”) if the UE detects a DCI format that provides a SPS PDSCH release or correctly decodes a transport block, and generates a negative acknowledgement (“NACK”) if the UE does not correctly decode the transport block. A HARQ-ACK information bit value of 0 represents a NACK while a HARQ-ACK information bit value of 1 represents an ACK.

In certain embodiments, the cyclic redundancy check (“CRC”) for a DCI format is scrambled with a C-RNTI, an MCS-C-RNTI, or a CS-RNTI.

In various embodiments, a UE has resources for PUCCH transmissions or for PUCCH and PUSCH transmissions that overlap in time and each PUCCH transmission is over a single slot without repetitions. Any case that a PUCCH transmission is with repetitions over multiple slots. If a UE is configured with multiple PUCCH resources in a slot to transmit CSI reports: 1) if the UE is not provided multi-CSI-PUCCH-ResourceList or if PUCCH resources for transmissions of CSI reports do not overlap in the slot, the UE determines a first resource corresponding to a CSI report with the highest priority, a) if the first resource includes PUCCH format 2, and if there are remaining resources in the slot that do not overlap with the first resource, the UE determines a CSI report with the highest priority, among the CSI reports with corresponding resources from the remaining resources, and a corresponding second resource as an additional resource for CSI reporting, and b) if the first resource includes PUCCH format 3 or PUCCH format 4, and if there are remaining resources in the slot that include PUCCH format 2 and do not overlap with the first resource, the UE determines a CSI report with the highest priority, among the CSI reports with corresponding resources from the remaining resources, and a corresponding second resource as an additional resource for CSI reporting; and 2) if the UE is provided multi-CSI-PUCCH-ResourceList and if any of the multiple PUCCH resources overlap, the UE multiplexes all CSI reports in a resource from the resources provided by multi-CSI-PUCCH-ResourceList.

A UE multiplexes DL HARQ-ACK information, with or without SR, and CSI report(s) in a same PUCCH if the UE is provided simultaneousHARQ-ACK-CSI; otherwise, the UE drops the CSI report(s) and includes only DL HARQ-ACK information, with or without SR, in the PUCCH, If the UE would transmit multiple PUCCHs in a slot that include DL HARQ-ACK information and CSI report(s), the UE expects to be provided a same configuration for simultaneousHARQ-ACK-CSI each of PUCCH formats 2, 3, and 4.

If a UE would multiplex CSI reports that include Part 2 CSI reports in a PUCCH resource, the UE determines the PUCCH resource and a number of PRBs for the PUCCH resource or a number of Part 2 CSI reports assuming that each of the CSI reports indicates rank 1.

If a UE would transmit multiple PUCCHs in a slot that include HARQ-ACK information, and/or SR, and/or CSI reports and any PUCCH with HARQ-ACK information in the slot satisfies the above timing conditions and does not overlap with any other PUCCH or PUSCH in the slot that does not satisfy the above timing conditions, the UE multiplexes the HARQ-ACK information, and/or SR, and/or CSI reports and determines corresponding PUCCH(s) for transmission in the slot according to the following pseudo-code. If the multiple PUCCHs do not include HARQ-ACK information and do not overlap with any PUSCH transmission by the UE in response to a DCI format detection by the UE, the timing conditions do not apply.

If: 1) a UE is not provided multi-CSI-PUCCH-ResourceList; and 2) a resource for a PUCCH transmission with HARQ-ACK information in response to SPS PDSCH reception and/or a resource for a PUCCH associated with a SR occasion overlap in time with two resources for respective PUCCH transmissions with two CSI reports; and 3) there is no resource for a PUCCH transmission with HARQ-ACK information in response to a DCI format detection that overlaps in time with any of the previous resources; and 4) the following pseudo code results to the UE attempting to determine a single PUCCH resource from the HARQ-ACK and/or the SR resource and the two PUCCH resources with CSI reports. Then the UE: 1) multiplexes the HARQ-ACK information and/or the SR in the resource for the PUCCH transmission with the CSI report having the higher priority; and 2) does not transmit the PUCCH with the CSI report having the lower priority.

Set Q to the set of resources for transmission of corresponding PUCCHs in a single slot without repetitions where: 1) a resource with earlier first symbol is placed before a resource with later first symbol: 2) for two resources with same first symbol, the resource with longer duration is placed before the resource with shorter duration: 3) for two resources with same first symbol and same duration, the placement is arbitrary (the above three steps for the set Q are according to a subsequent pseudo-code for a function order (Q)): 4) a resource for negative SR transmission that does not overlap with a resource for HARQ-ACK or CSI transmission is excluded from set Q: 5) if the UE is not provided simultaneousHARQ-ACK-CSI and resources for transmission of HARQ-ACK information include PUCCH format 0 or PUCCH format 2, resources that include PUCCH format 2, or PUCCH format 3, or PUCCH format 4 for transmission of CSI reports are excluded from the set Q if they overlap with any resource from the resources for transmission of HARQ-ACK information: 6) if the UE is not provided simultaneousHARQ-ACK-CSI and at least one of the resources for transmission of HARQ-ACK information includes PUCCH format 1, PUCCH format 3, or PUCCH format 4, then resources that include PUCCH format 3 or PUCCH format 4 for transmission of CSI reports are excluded from the set Q, and resources that include PUCCH format 2 for transmission of CSI reports are excluded from the set Q if they overlap with any resource from the resources for transmission of HARQ-ACK information.

In certain embodiments, set e(Q) to the cardinality of Q, set Q(j,0) to be the first symbol of resource Q(j) in the slot, set L (Q(j)) to be the number of symbols of resource Q(j) in the slot, set j=0—index of first resource in set Q, set o=0—counter of overlapped resources while j≤e(Q)−1, if j<e(Q)−1 and resource Q(j−o) overlaps with resource Q(j+1), 0=0+1 j=J+1, else if 0>0 determine a single resource for multiplexing UCI associated with resources {(j−o).Q(j−0+1) . . . . Q(j)}, set the index of the single resource to j Q=Q\{(j−o), Q(j−o+1) . . . Q(j−1)}, j=0% start from the beginning after reordering unmerged resources at next step, 0=0, order (Q) % function that re-orders resources in current set Q, set e(Q) to the cardinality of Q, else J=J+1 end if, end if, end while

The function order (Q) performs the following pseudo-code: {K=0 while k<C (Q)−1% the next two while loops are to re-order the unmerged resources, l=0 while l<(@)−1−k, if Q(1.0)>Q(+10) OR (Q(l, 0)=Q(+1.0) & Q(Q(I)<Q(Q(+1), temp=Q(I) Q(I)=Q(1+1): Q(1+1)=temp end if. 1=1+1, end while, k=k+1, end while}.

For each PUCCH resource in the set Q that satisfies the aforementioned timing conditions, when applicable: 1) the UE transmits a PUCCH using the PUCCH resource if the PUCCH resource does not overlap in time with a PUSCH transmission after multiplexing UCI following certain procedures: 2) the UE multiplexes HARQ-ACK information and/or CSI reports in a PUSCH if the PUCCH resource overlaps in time with a PUSCH transmission, and does not transmit SR—in case the PUCCH resource overlaps in time with multiple PUSCH transmissions, the PUSCH for multiplexing HARQ-ACK information and/or CSI is selected-if the PUSCH transmission by the UE is not in response to a DCI format detection and the UE multiplexes only CSI reports, the timing conditions are not applicable; and/or 3) the UE does not expect the resource to overlap with a second resource of a PUCCH transmission over multiple slots if the resource is obtained from a group of resources that do not overlap with the second resource.

In various embodiments: 1) resources for transmissions of UCI types, prior to multiplexing or dropping, overlap in a slot: 2) multiplexing conditions of corresponding UCI types in a single PUCCH are satisfied; and 3) the UE does not transmit any PUSCH time-overlapping with PUCCH in the slot.

For a transmission occasion of a single CSI report, a PUCCH resource is provided by pucch-CSI-Resource List. For a transmission occasion of multiple CSI reports, corresponding PUCCH resources can be provided by multi-CSI-PUCCH-ResourceList. If a UE is provided first and second PUCCH-Config, multi-CSI-PUCCH-ResourceList is provided by the first PUCCH-Config, and PUCCH-ResourceId in pucch-CSI-ResourceList or multi-CSI-PUCCH-ResourceList indicates a corresponding PUCCH resource in PUCCH-Resource provided by the first PUCCH-Config.

If a UE is provided only one PUCCH resource set for transmission of HARQ-ACK information in response to PDSCH reception scheduled by a DCI format or in response to a SPS PDSCH release or in response to a SCell dormancy indication, the UE does not expect to be provided simultaneousHARQ-ACK-CSI. A UE is configured by maxCodeRate a code rate for multiplexing HARQ-ACK, SR, and CSI report(s) in a PUCCH transmission using PUCCH format 2, PUCCH format 3, or PUCCH format 4.

If a UE transmits CSI reports using PUCCH format 2, the UE transmits only wideband CSI for each CSI report. In the following, a Part 1 CSI report refers either to a CSI report with only wideband CSI or to a Part 1 CSI report with wideband CSI and sub-band CSI.

Denote as: O_{ACK} a total number of HARQ-ACK information bits, if any, and O SR a total number of SR bits. O_{SR}=0 if there is no scheduling request bit: otherwise, O_{SR}=[log₂(K+1)].

$${O}_{CSI} = {\sum }_{n = 1}^{{N}_{CSI}^{total}} ( {O}_{CSI - part 1 , n} + {O}_{CSI - part 2 , n} ) ,$$

where O_{CSI-part1,n} is a number of part 1 CSI report bits for CSI report with priority value n, O_{CSI-part2,n} is a number of Part 2 CSI report bits, if any, for CSI report with priority value n, and V_{CSI}^{total} is a number of CSI reports that include overlapping CSI reports. O_{CRC}=O_{CRCCSEpart1}+O_{CRCCStpart2}, Where O_{CRC,CSI-part1} is a number of CRC bits, if any, for encoding HARQ-ACK, SR and Part 1 CSI report bits and O_{CRC,CSI-part2} is a number of CRC bits, if any, for encoding Part 2 CSI report bits.

In some embodiments: 1) r is a code rate given by maxCodeRate: 2) M_{RB}^{PUCCH} is a number of PRBs for PUCCH format 2, or PUCCH format 3, or PUCCH format 4, respectively, where M_{RB}^{PUCCH} is provided by nrofPRBs in PUCCH-format2 for PUCCH format 2 or by nrofPRBs in PUCCH-format3 for PUCCH format 3, and M_{RB}^{PUCCH}=1 for PUCCH format 4; 3) N_{sc,crtl}^{RB}=N_{sc}^{RB}−4 for PUCCH format 2 or, if the PUCCH resource with PUCCH format 2 includes an orthogonal cover code with length N_{SF}^{PUCCH,2} provided by occ-Length, N_{sc,ctrl}^{RB}=(N_{sc}^{RB}−4)/N_{SF}^{PUCCH,2}, N_{sc,ctrl}^{RB}=N_{sc}^{RB} PUCCH format 3 or, if the PUCCH resource with PUCCH format 3 includes an orthogonal cover code with length N_{SF}^{PUCCH,3} provided by occ-Length, N_{sc.ctrl}^{RB}=N_{sc}^{RB}/N_{SF}^{PUCCH,3}, and N_{sc,ctrl}^{RB}=N_{sc}^{RB}\N_{SF}^{PUCCH,4} for PUCCH format 4, where N_{sc}^{RB} is a number of subcarriers per resource block; 4) N_{symb-UCI}^{PUCCH} is equal to a number of PUCCH symbols N_{symb}^{PUCCH,2} for PUCCH format 2 provided by nrofSymbols in PUCCH-format2. For PUCCH format 3 or for PUCCH format 4, N_{symb-UCI}^{PUCCH} is equal to a number of PUCCH symbols N_{symb}^{PUCCH,3} for PUCCH format 3 or equal to a number of PUCCH symbols N_{symb}^{PUCCH,4} for PUCCH format 4 provided by nrofSymbols in PUCCH-format3 or nrofSymbols in PUCCH-format4, respectively, after excluding a number of symbols used for DM-RS transmission for PUCCH format 3 or for PUCCH format 4, respectively; and/or 5) Qₘ=1 if pi/2-BPSK is the modulation scheme and Q=2 if QPSK is the modulation scheme as indicated by pi2BPSK for PUCCH format 3 or PUCCH format 4. For PUCCH format 2, Qₘ=2.

If a UE has one or more CSI reports and zero or more HARQ-ACK/SR information bits to transmit in a PUCCH where the HARQ-ACK, if any, is in response to a PDSCH reception without a corresponding PDCCH: 1) if any of the CSI reports are overlapping and the UE is provided by multi-CSI-PUCCH-ResourceList with J≤2 PUCCH resources in a slot, for PUCCH format 2 and/or PUCCH format 3 and/or PUCCH format 4, where the resources are indexed according to an ascending order for the product of a number of corresponding resource elements (“REs”), modulation order Qₘ and configured code rate r: 2) if (O_{ACK}+O_{SR}+O_{CSI}+O_{CRC})≤(M_{RB}^{PUCCH}·N_{sc,ctrl}^{RB}·N_{symb-UCI}^{PUCCH}·Qₘ·r), the UE uses PUCCH format 2 resource 0, or the PUCCH format 3 resource 0, or the PUCCH format 4 resource 0; 3) else if (O_{ACK}+O_{SR}+O_{CSI}+O_{CRC})>(M_{RB}^{PUCCH}·N_{sc,ctrl}^{RB}·N_{symb,UCI}^{PUCCH}·Qₘ·r), and (O_{ACK}+O_{SR}+O_{CSI}+O_{CRC})<(M_{RB}^{PUCCH}·N_{sc,ctrl}^{RB}·N_{symb-UCI}^{PUCCH}·Qₘ·r)ⱼ₊₁. 0<j<J−1, the UE transmits a PUCCH conveying HARQ-ACK information, SR and CSI report(s) in a respective PUCCH where the UE uses the PUCCH format 2 resource j+1, or the PUCCH format 3 resource j+1, or the PUCCH format 4 resource j+1:4) else the UE uses the PUCCH format 2 resource J−1, or the PUCCH format 3 resource J−1, or the PUCCH format 4 resource J−1 and the UE selects A reported CSI report(s) for transmission together with HARQ-ACK information and SR, when any, in ascending priority value; and/or 5) else, the UE transmits the O_{ACK}+O_{SR}+O_{CSI}+O_{CRC} bits in a PUCCH resource provided by pucch-CSI-ResourceList and determined.

If a UE has HARQ-ACK, SR and wideband or sub-band CSI reports to transmit and the UE determines a PUCCH resource with PUCCH format 2, or the UE has HARQ-ACK, SR and wideband CSI reports to transmit and the UE determines a PUCCH resource with PUCCH format 3 or PUCCH format 4, where the UE determines the PUCCH resource using the PUCCH resource indicator field in a last of a number of DCI formats with a value of a PDSCH-to-HARQ_feedback timing indicator field, if present, or a value of dl-DataToUL-ACK, or dl-DataToUL-ACK-r16, or dl-DataToUL-ACKForDCIFormat1_2, indicating a same slot for the PUCCH transmission, from a PUCCH resource set provided to the UE for HARQ-ACK transmission, and the UE determines the PUCCH resource set for O_{UCI} UCI bits, and if (O_{ACK}+O_{SR}+O_{CSI-part1}+O_{CRC,CSI-part1})≤M_{RB,min}^{PUCCH}·N_{sc,ctrl}^{RB}·N_{symb-UCI}^{PUCCH}·Qₘ·r, the UE transmits the HARQ-ACK, SR, and CSI reports bits by selecting the minimum number M_{RB,min}^{PUCCH} of the M_{RB}^{PUCCH} PRBs satisfying (O_{ACK}+O_{SR}+O_{CSI-part1}+O_{CRC,CSI-part1})≤M_{RB,min}^{PUCCH}·N_{sc.ctrl}^{RB}·N_{symb-UCI}^{PUCCH}·Qₘ·r: else, the UE selects A reported CSI report(s), from the N_{CSI}^{total} CSI reports, for transmission together with HARQ-ACK and SR in ascending priority value, where the value of N_{CSI}^{reported} satisfies

$$( {O}_{ACK} + {O}_{SR} + {\sum }_{n = 1}^{{N}_{CSI}^{reported}} {O}_{CSI - part 1 , n} + {O}_{CRC , CSI - part 1 , N} ) \leq {M}_{R B}^{PUCCH} \cdot {N}_{sc , ctrl}^{R H} \cdot {N}_{symb - UCI}^{PUCCH} \cdot {Q}_{m} \cdot r and$$

$$( {O}_{ACK} + {O}_{SR} + {\sum }_{n = 1}^{{N}_{CSI}^{reported} + 1} {O}_{CSI - part , n} + {O}_{CRC , CSI - part 1 , N + 1} ) > {M}_{R B}^{PUCCH} \cdot {N}_{sc , ctrl}^{R B} \cdot {N}_{symb - UCI}^{PUCCH} \cdot {Q}_{m} \cdot r ,$$

where O_{CRC,CSI-part1,N} is a number of CRC bits corresponding to

$${O}_{ACK} + {O}_{S R} + {\sum }_{n = 1}^{{N}_{CSI}^{reported}} {O}_{CSI - part 1 , n} UCI bits ,$$

and O_{CRC,CSI-part1,N+1} is a number of CRC bits corresponding to

$${O}_{ACK} + {O}_{SR} + {\sum }_{n = 1}^{{N}_{CSI}^{reported} + 1} {O}_{CSI - part 1 , n}$$

UCI bits.

If a UE is provided a first interlace of M_{Interlace,0}^{PUCCH} PRBs by interlace0 in InterlaceAllocation, the UE has HARQ-ACK, SR and wideband or sub-band CSI reports to transmit, and the UE determines a PUCCH resource with PUCCH format 2, or the UE has HARQ-ACK, SR and wideband CSI reports to transmit and the UE determines a PUCCH resource with PUCCH format 3, where the UE determines the PUCCH resource using the PUCCH resource indicator field in a last of a number of DCI formats with a value of a PDSCH-to-HARQ_feedback timing indicator field indicating a same slot for the PUCCH transmission, from a PUCCH resource set provided to the UE for HARQ-ACK transmission, and the UE determines the PUCCH resource set for O_{UCI} UCI bits and if (O_{ACK}+O_{SR}+O_{CSI-part1}+O_{CRC,CSI-part1})≤M_{Interlace,0}^{PUCCH}·N_{sc,ctrl}^{RB}·N_{symb-UCI}^{PUCCH}·Qₘ·r, the UE transmits the HARQ-ACK, SR, and CSI reports bits in a PUCCH over the first interlace: else, if the UE is provided a second interlace of M_{Interlace,1}^{PUCCH} PRBs by interlace1 and if (O_{ACK}+O_{SR}+O_{CSI-part1}+O_{CRC,CSI-part1})≤(M_{Interlace,0}^{PUCCH} +M_{Interlace,1}^{PUCCH})·N_{sc.ctrl}^{RB}·N_{symb-UCI}^{PUCCH}·Qₘ·r, the UE transmits the HARQ-ACK, SR, and CSI reports bits in a PUCCH over both the first and second interlaces: else, the procedure is same as the corresponding one when the UE is provided PUCCH-ResourceSet by replacing M_{RB}^{PUCCH} with M_{Interlace,0}^{PUCCH}, or, if the UE is provided interlace1, by M_{Interlace,0}^{PUCCH}+M_{Interlace,1}^{PUCCH}.

If a UE has HARQ-ACK, SR and sub-band CSI reports to transmit and the UE determines a PUCCH resource with PUCCH format 3 or PUCCH format 4, where the UE determines the PUCCH resource using the PUCCH resource indicator field in a last of a number of DCI formats with a value of a PDSCH-to-HARQ_feedback timing indicator field indicating a same slot for the PUCCH transmission, from a PUCCH resource set provided to the UE for HARQ-ACK transmission, and the UE determines the PUCCH resource set as described in Clause 9.2.1 and Clause 9.2.3 for O_{UCI} UCI bits and if (O_{ACK}+O_{SR}+O_{CSI}+O_{CRC})≤M_{RB}^{PUCCH}·N_{sc,ctrl}^{RB}·N_{symb-UCI}^{PUCCH}·Qₘ·r, the UE transmits the HARQ-ACK, SR and the N_{SCI}^{total} CSI report bits by selecting the minimum number M_{RB,min}^{PUCCH} of PRBs from the M_{RB}^{PUCCH} PRBs satisfying (O_{ACK}+O_{SR}+O_{CSI}+O_{CRC})≤M_{RB,min}^{PUCCH}·N_{sc,ctrl}^{RB}·M_{symb-UCI}^{PUCCH}·Qₘ·r; else, if for N_{CSI-part2}^{reported}>0 Part 2 CSI report priority value(s), it is

$${\sum }_{n = 1}^{{N}_{CSI - part 2}^{reported}} {O}_{CSI - part 2 , n} + {O}_{CRC , CSI - part 2 , N} \leq ( {M}_{RB}^{PUCCH} \cdot {N}_{sc , ctrl}^{R B} \cdot {N}_{symb - UCI}^{PUCCH} - ⌈ ( {O}_{ACK} + {O}_{SR} + {\sum }_{n = 1}^{{N}_{CSI}^{total}} {O}_{CSI - part 1 , n} + {O}_{CRC , CSI - part 1} ) / ( {Q}_{m} \cdot r ) ⌉ ) \cdot {Q}_{m} \cdot r$$

$$and$$

$${\sum }_{n = 1}^{{N}_{CSI - part 2}^{reported} + 1} {O}_{CSI - part 2 , n} + {O}_{CRC , CSI - part 2 , N + 1} > ( {M}_{RB}^{PUCCH} \cdot {N}_{sc , ctrl}^{RB} \cdot {N}_{symb - UCI}^{PUCCH} - ⌈ ( {O}_{ACK} + {O}_{SR} + {\sum }_{n = 1}^{{N}_{CSI}^{total}} {O}_{CSI - part 1 , n} + {O}_{CRC , CSI - part 1} ) / ( {Q}_{m} \cdot r ) ⌉ ) \cdot {Q}_{m} \cdot r .$$

The UE selects the first A reported N_{CSI-part2}^{reported} Part 2 CSI reports, according to respective priority value(s), for transmission together with the HARQ-ACK, SR and N_{CSI}^{total} Part 1 CSI reports, where O_{CSI-part1.n} is the number of Part 1 CSI report bits for the nₜₕ CSI report and O_{CSI-part2,n} is the number of Part 2 CSI report bits for the nₜₕ CSI report priority value, O_{CRC,CSI-part2.N} is a number of CRC bits corresponding to

$${\sum }_{n = 1}^{{N}_{CSI - part 2}^{reported}} {O}_{CSI - part 2 , n} ,$$

and O_{CRC,CSI-part1,N+1} is a number of CRC bits corresponding to

$${\sum }_{n = 1}^{{N}_{CSI - part 2}^{reported} + 1} {O}_{CSI - part 2 , n} ;$$

else, the UE drops all Part 2 CSI reports and selects N_{CSI-part1}^{reported} reported Part 1 CSI report(s), from the total CSI reports in ascending priority value, for transmission together with the HARQ-ACK and SR information bits where the value of N_{CSI-part1}^{reported} satisfies

$$( {O}_{A C K} + {O}_{S R} + {\sum }_{n = 1}^{{N}_{CS1 - part 1}^{reported}} {O}_{CSI - part 1 , n} + {O}_{CRC , CSI - part 1 , N} ) \leq {M}_{R B}^{PUCCH} \cdot {N}_{sc , ctrl}^{R B} \cdot {N}_{s ymb - UCI}^{PUCCH} \cdot {Q}_{m} \cdot r$$

$$and$$

$$( {O}_{A C K} + {O}_{S R} + {\sum }_{n = 1}^{{N}_{CS1 - part 1}^{reported} + 1} {O}_{CSI - part 1 , n} + {O}_{CRC , CSI - part 1 , N + 1} ) > {M}_{R B}^{PUCCH} \cdot {N}_{sc , ctrl}^{R B} \cdot {N}_{s ymb - UCI}^{PUCCH} \cdot {Q}_{m} \cdot r ,$$

where O_{CRC,CSI-part1,N} is a number of CRC bits corresponding to

$${O}_{ACK} + {O}_{SR} + {\sum }_{n = 1}^{{N}_{CSI - part 1}^{reported}} {O}_{CSI - part 1 , n}$$

UCI bits, and O_{CRC,CSI-part1,N+1} IS a number of CRC bits corresponding to

$${O}_{ACK} + {O}_{SR} + {\sum }_{n = 1}^{{N}_{CSI - part 1}^{reported} + 1} {O}_{CSI - part 1 , n}$$

UCI bits.

If a UE is provided a first interlace of M_{Interlace,0}^{PUCCH} PRBs by interlace0 in Interlace Allocation, the UE has HARQ-ACK, SR and sub-band CSI reports to transmit, and the UE determines a PUCCH resource with PUCCH format 3, where the UE determines the PUCCH resource using the PUCCH resource indicator field in a last of a number of DCI formats that have a value of a PDSCH-to-HARQ_feedback timing indicator field indicating a same slot for the PUCCH transmission, from a PUCCH resource set provided to the UE for HARQ-ACK transmission, and the UE determines the PUCCH resource set as described in Clauses 9.2.1 and 9.2.3 for O_{UCI} UCI bits, and if (O_{ACK}+O_{SR}+O_{CSI}+O_{CRC})≤M_{Interlace,0}^{PUCCH}·N_{sc,ctrl}^{RB}·N_{symb-UCI}^{PUCCH}·Qₘ·r, the UE transmits the HARQ-ACK, SR and the N_{CSI}^{total} CSI report bits in a PUCCH over the first interlace: else if the UE is provided a second interlace of M_{Interlace,1}^{PUCCH} PRBs by interlace1 and if (O_{ACK}+O_{SR}+O_{CSI}+O_{CRC})≤ (M_{Interlace,0}^{PUCCH}+M_{Interlace,1}^{PUCCH})·N_{sc,ctrl}^{RB}·N_{symb-UCI}^{PUCCH}·Qₘ·r, the UE transmits the HARQ-ACK, SR, and CSI reports bits in a PUCCH over both the first and second interlaces: else, the procedure is same as the corresponding one when the UE is provided PUCCH-ResourceSet by replacing M_{RB}^{PUCCH} with M_{Interlace,0}^{PUCCH}, or, if the UE is provided interlace1, with M_{Interlace,0}^{PUCCH}+M_{Interlace,1}^{PUCCH}. Table 1 illustrated a code rate r corresponding to value of maxCodeRate.

TABLE 1
Code rate r corresponding to value of maxCodeRate

| maxCodeRate | Code rate r |
|---|---|
| 0 | 0.08 |
| 1 | 0.15 |
| 2 | 0.25 |
| 3 | 0.35 |
| 4 | 0.45 |
| 5 | 0.60 |
| 6 | 0.80 |
| 7 | Reserved |

In certain embodiments, a UE has resources for PUCCH transmissions or for PUCCH and PUSCH transmissions that overlap in time. It should be noted that one or more elements or features from one or more of the embodiments described herein may be combined.

In one embodiment, in response to a UE determining overlapping for PUCCH and/or PUSCH transmissions of different priority indexes, the UE first resolves the overlapping for PUCCH and/or PUSCH transmissions with the same priority index for each priority index.

In a first embodiment, there may be coding of HP CSI in a PUCCH carrying UCI of mixed priorities. In one embodiment, if a UE would transmit LP UCI in a first PUCCH and would transmit HP UCI including HP CSI in a second PUCCH overlapping with the first PUCCH in time and if the UE determines a PUCCH resource of a PUCCH configuration with PUCCH format 2, PUCCH format 3, or PUCCH format 4 for multiplexing at least a part of LP UCI with the HP UCI, where the HP CSI includes two parts (e.g., CSI-part1 and CSI-part2).

In a first method, a UE performs first encoding with HP UCI bits of HP HARQ-ACK, HP SR, and/or HP CSI-part1 and performs second encoding with LP HARQ-ACK, LP SR, and/or HP CSI-part2. That is, HP CSI-part2 is jointly encoded with the multiplexed LP UCI bits. The UE may determine to jointly encode HP CSI-part2 with LP HARQ-ACK/LP SR, if the UE can include all of HP CSI-part1 reports (e.g., no omission of any HP CSI-part1 reports) for transmission on the PUCCH resource. Otherwise, the UE drops HP CSI-part2. In one example, if the UE omits some of the HP CSI-part1 reports (e.g., according to respective priority values as), the UE also omits HP CSI-part2 associated to the omitted HP CSI-part1 reports.

In one implementation, the UE prioritizes LP HARQ-ACK and/or LP SR over HP CSI-part 2 and selects the first N_{CSI-part2}^{reported}, part 2 HP CSI reports (e.g., HP CSI part 2 priority levels, with omission of part 2 CSI according to a priority order beginning with a lowest priority level, with priority 0 being the highest priority and priority 2Nrep being the lowest priority) to multiplex, according to respective priority values and a number of PRBs and/or REs available for HP CSI-part2. The number of available PRBs and/or REs for HP CSI-part2 is determined by subtracting a number of PRBs/REs used for first encoded bits (e.g., resulting from first encoding) and a number of PRBs/REs used for LP HARQ-ACK/LP SR from a total number of available PRBs/REs of the PUCCH resource.

In another implementation, the UE prioritizes HP CSI-part2 over LP HARQ-ACK and/or LP SR and selects the first N_{CSI-part2}^{reported} part 2 HP CSI reports to multiplex, according to respective priority values and a number of PRBs and/or REs available for HP CSI-part2. The number of available PRBs and/or REs for HP CSI-part2 is determined by subtracting a number of PRBs/REs used for first encoded bits (e.g., resulting from first encoding) from a total number of available PRBs/REs of the PUCCH resource. If a number of available PRBs/REs for LP HARQ-ACK/LP SR is zero, the UE does not multiplex LP HARQ-ACK/LP SR.

In yet another implementation, HP CSI-part2 and LP HARQ-ACK/LP SR are equally prioritized. The UE includes all of HP CSI-part2 reports and LP HARQ-ACK/SR for second encoding.

In a second method, a UE performs first encoding with HP UCI bits of HP HARQ-ACK, HP SR, and/or HP CSI-part1 and performs second encoding with LP UCI bits of LP HARQ-ACK and/or LP SR. That is, HP CSI-part2 is not transmitted in the PUCCH resource.

In a third method, a UE performs first encoding with HP UCI bits of HP HARQ-ACK, HP SR, and/or HP CSI (e.g., including both HP CSI-part1 and HP CSI-part2) and performs second encoding with LP UCI bits of LP HARQ-ACK and/or LP SR. That is, HP CSI-part2 is jointly encoded with other HP UCI bits.

In various embodiments, a UE prioritizes HP HARQ-ACK, HP scheduling request (“SR”), and HP CSI-part1 over HP CSI-part2 and selects the first N_{CSI-part2}^{reported} part 2 HP CSI reports to multiplex, according to respective priority values and a number of PRBs and/or REs available for HP CSI-part2.

In one implementation, a number of available PRBs and/or REs for HP CSI-part2 is determined by subtracting a number of PRBs/REs to be used for HP HARQ-ACK/HP SR/HP CSI-part 1 from a total number of available PRBs/REs of the PUCCH resource. If the UE cannot include all of HP CSI-part1 reports for transmission on the PUCCH resource, the UE drops HP CSI-part2 and LP HARQ-ACK/LP SR.

In another implementation, the number of available PRBs and/or REs for HP CSI-part2 is determined by subtracting a number of PRBs/REs to be used for HP HARQ-ACK/HP SR/HP CSI-part1 from a number of PRBs/REs available for HP UCI. If the UE cannot include all of HP CSI-part1 reports for transmission on the PUCCH resource, the UE drops HP CSI-part2.

In some examples, the UE may omit a portion of the HP CSI-part2, for example, until the second encoding code rate (e.g., for the first method) or first encoding code rate (e.g., for the third method) is less or equal to a threshold max code rate. The threshold code max rate may be configured by higher layers (e.g., radio resource control (“RRC”) signaling). In one example, the threshold code max rate may correspond to the max code rate (e.g., received in PUCCH configuration) for the HP UCI (e.g., for the third method). In another example, the threshold code maximum rate may correspond to a maximum code rate for the LP UCI (e.g., for the first method).

In one implementation, the UE determines the PUCCH resource based on: 1) one or more semi-statically configured PUCCH resources and the total UCI size (e.g., including the HP UCI and the multiplexed LP UCI): or 2) a PUCCH resource indicator field in a last of a number of DCI formats indicating a same slot/subslot for the PUCCH transmission, semi-statically configured one or more sets of PUCCH resources, and the total UCI size.

In certain implementations, the UE reports a capability to whether CSI-part2 can be jointly encoded with the multiplexed LP UCI bits.

In an example, the UE is indicated by RRC signaling whether CSI-part2 can be jointly encoded with the multiplexed LP UCI bits (e.g., in case of overlap of LP PUCCH/PUSCH with HP PUCCH/PUSCH). In another example, a new RRC parameter simultaneousHARQ-ACK-CSI-LP is indicated along with the existing RRC parameter simultaneousHARQ-ACK-CSI to allow/not allow joint encoding of CSI and LP UCI.

In a further example, a threshold priority is signalled, and the UE only jointly encodes CSI reports with priority value above the threshold with LP/HP UCI bits. In another example, priorities of CSI-part1 and CSI-part2 for a CSI report are determined. In certain examples, CSI-part2 CSI reports having a priority value above/below a threshold are jointly encoded with LP UCI bits.

In one example, CSI reports indicating statistics of a CSI reporting quantity such as statistics of channel quality indicator (“CQI”) have high priority, and jointly encoded with HP UCI.

In certain examples, whether a CSI report can be jointly encoded with LP UCI bits is indicated via an RRC parameter in the corresponding CSI report configuration (e.g., as signaled via CSI-ReportConfig).

In a second embodiment, there may be multiplexing and mapping of mixed priority UCI bits to physical resources in PUCCH.

Notations used for explaining different embodiments herein are defined as follows:

O_{HP UCI} and O_{HP, CRC} are the number of multiplexed HP UCI bits and the number of HP UCI CRC bits, respectively, for transmission on a PUCCH carrying multiplexed UCI bits of mixed priorities. If the payload size is not larger than a threshold value (e.g., 11 bits), CRC bits may not be attached. O_{LP UCI} and O_{LP, CRC} are the number of multiplexed LP UCI bits and the number of LP UCI CRC bits, respectively, for transmission on a PUCCH carrying multiplexed UCI bits of mixed priorities. If the payload size is not larger than a threshold value (e.g., 11 bits), CRC bits may not be attached.

M_{PRB}^{PUCCH} is the configured maximum number of PRBs for a given PUCCH format (e.g., PUCCH format 2 or PUCCH format 3). M_{HP_RB}^{PUCCH} is the maximum number of PRBs configured for HP UCI for a given PUCCH format (e.g., PUCCH format 2 or PUCCH format 3). M_{LP-RB}^{PUCCH} is the maximum number of PRBs configured for LP UCI for a given PUCCH format (e.g., PUCCH format 2 or PUCCH format 3).

R_{HP UCI}^{max} is the configured maximum PUCCH coding rate for HP UCI. R_{LP UCI}^{max} is the configured maximum PUCCH coding rate for LP UCI. N_{symb,UCI}^{PUCCH} IS the number of PUCCH symbols used for UCI transmission (e.g., excluding a number of symbols used for DM-RS transmission for PUCCH format 3 or for PUCCH format 4) in a PUCCH.

Qₘ is the modulation order of a PUCCH, Qₘ=1 if pi/2-BPSK is the modulation scheme and Qₘ=2 if quadrature phase shift keying (“QPSK”) is the modulation scheme as indicated by pi2BPSK for PUCCH format 3 or PUCCH format 4. For PUCCH format 2, Qₘ=2. N_{sc,ctrl}^{RB}=N_{sc}^{RB}−4 for PUCCH format 2 or, if the PUCCH resource with PUCCH format 2 includes an orthogonal cover code with length N_{SF}^{PUCCH,2} provided by occ-Length, N_{sc,ctrl}^{RB}=(N_{sc}^{RB}−4)\N_{SF}^{PUCCH,2}, N_{sc,ctrl}^{RB}=N_{sc}^{RB} for PUCCH format 3 or, if the PUCCH resource with PUCCH format 3 includes an orthogonal cover code with length N_{SF}^{PUCCH,3} provided by occ-Length, N_{sc.ctrl}^{RB}=N_{sc}^{RB}/N_{SF}^{PUCCH,3}, and N_{sc,ctrl}^{RB}=N_{sc}^{RB}\N_{SF}^{PUCCH,4} for PUCCH format 4, where N_{sc}^{RB} is a number of subcarriers per resource block.

In one embodiment, if a UE would transmit LP UCI in a first PUCCH and would transmit HP UCI in a second PUCCH overlapping with the first PUCCH in time and if the UE determines a PUCCH resource of a PUCCH configuration with PUCCH format 2 or PUCCH format 3 for multiplexing at least a part of LP UCI with the HP UCI.

In a first method of the second embodiment, the UE determines a number of PRBs of the PUCCH resource based on the maximum number of PRBs for the HP UCI and the maximum number of PRBs for the LP UCI. If the UE receives information of separate values of maxCodeRate, a first value for HP UCI and a second value for LP UCI in the PUCCH configuration, the UE applies corresponding maxCodeRate values to determine a number of PRBs required for the HP UCI and a number of PRBs for the multiplexed LP UCI, respectively.

If the UE receives information of separate values of nrofPRBs for PUCCH format 2 or PUCCH format 3, a first value for HP UCI and a second value for LP UCI, the UE applies corresponding nrofPRBs values to determine the maximum number of PRBs for the HP UCI and the maximum number of PRBs for the multiplexed LP UCI, respectively. If the UE receives information of one value of maxCodeRate and/or one value of nrofPRBs, the UE assumes that the one value of maxCodeRate and/or the one value of nrofPRBs is applicable to both the HP UCI and the multiplexed LP UCI.

Once the UE identifies applicable values of maxCodeRate and/or nrofPRBs for the HP UCI and the multiplexed LP UCI, the UE determines the number of PRBs for the HP UCI and the number of PRBs for the multiplexed LP UCI, respectively, and determines the number of PRBs of the PUCCH resource based on the number of PRBs for the HP UCI and the number PRBs for the multiplexed LP UCI.

For example, the UE determines the number of PRBs N_{HP-RB}^{PUCCH} for the HP UCI by selecting the minimum number M_{HP-RB, min}^{PUCCH} of the M_{HP-RB}^{PUCCH} PRBs satisfying (O_{HP UCI}+O_{HP, CRC})≤M_{HP-RB,min}^{PUCCH}·N_{sc,ctrl}^{RB}·N_{symb,UCI}^{PUCCH}·Qₘ·R_{HP UCI}^{max}. The UE determines the number of PRBs N_{LP-RB}^{PUCCH} for the multiplexed LP UCI by selecting the minimum number M_{LP-RB,min}^{PUCCH} of the M_{LP-RB}^{PUCCH} PRBs satisfying (O_{LP UCI}+O_{LP, CRC})≤M_{LP-RB,min}^{PUCCH}·N_{sc,ctrl}^{RB}·N_{symb,UCI}^{PUCCH}·Qₘ·R_{LP UCI}^{max}. The total number of PRBs N_{PRB}^{PUCCH} of the PUCCH resource is determined as M_{HP-RB,min}^{PUCCH}+M_{LP-RB,min}^{PUCCH}. The UE may select a part of HP UCI bits and/or a part of LP UCI bits for multiplexing so that effective coding rates of the multiplexed HP UCI and LP UCI bits are no larger than corresponding maxCodeRate values. Alternatively, the UE determines the number of PRBs N_{HP-RB}^{PUCCH} for the HP UCI as M_{HP-RB}^{PUCCH} (e.g., largest value such that the condition is satisfied), if (O_{HP UCI}+O_{HP, CRC})>M_{HP-RB}^{PUCCH}·N_{sc,ctrl}^{RB}·N_{symb,UCI}^{PUCCH}·Qₘ·R_{HP UCI}^{max}, and determines the number of PRBs N_{LP-RB}^{PUSCH} for the LP UCI as M_{LP-RB}^{PUCCH} (e.g., largest value such that the condition is satisfied), if (O_{LP UCI}+O_{LP, CRC})>M_{LP-RB}^{PUCCH}·N_{sc,ctrl}^{RB}·N_{symb,UCI}^{PUCCH}·Qₘ·R_{LP UCI}^{max}.

In one implementation, if the UE employs separate coding of LP UCI and HP UCI to transmit the LP UCI and HP UCI in the PUCCH resource, the UE performs rate-matching for coded LP and HP UCI bits, which results in rate-matching output sequences with respective lengths shown in Table 2. In some implementations, LP UCI and HP CSI-part2 may be jointly encoded

TABLE 2
Rate matching output sequence length E_{UCI}

| UCI(s) for | | |
|---|---|---|
| transmission on a | UCI for | |
| PUCCH | encoding | Value of E_{UCI} |
| LP UCI and HP | LP UCI (e.g. LP | E_{UCI} = N_{LP-RB}^{PUCCH} · N_{sc, ctrl}^{RB} · N_{symb, UCI}^{PUCCH} · Qₘ · R_{LP UCI}^{max} |
| UCI | HARQ-ACK | |
| | and/or LP SR) | |
| | HP UCI (e.g. | E_{UCI} = N_{HP-RB}^{PUCCH} · N_{sc, ctrl}^{RB} · N_{symb, UCI}^{PUCCH} · Qₘ · R_{HP UCI}^{max} |
| | HP HARQ- | |
| | ACK, HP SR, | |
| | and/or HP CSI) | |

In a second method of the second embodiment, the UE determines a number of PRBs of the PUCCH resource by selecting the minimum number N_{PRB,min}^{PUCCH} of the N_{PRB}^{PUCCH} PRBs satisfying [(O_{HP UCI}+O_{HP,CRC})/REP UCI/Qₘ]+[(O_{LP UCI}+O_{LP,CRC})/R_{LP UCI}^{max}/Qₘ]<N_{PRB,min}^{PUCCH}·N_{sc,ctrl}^{RB}·N_{symb, UCI}^{PUCCH}.

The UE receives information of one nrofPRBs value for a corresponding PUCCH format (e.g., PUCCH format 2, PUCCH format 3) of the PUCCH configuration, for the multiplexed HP and LP UCI bits.

If the UE receives information of separate values of maxCodeRate, a first value for HP UCI and a second value for LP UCI in the PUCCH configuration, the UE applies corresponding maxCodeRate values to determine a number of REs required for the HP UCI and a number of REs for the multiplexed LP UCI, respectively. If the UE receives information of one value of maxCodeRate, the UE assumes that the one value of maxCodeRate is applicable to both the HP UCI and the multiplexed LP UCI.

In one implementation, the UE may select a part of HP UCI bits and/or a part of LP UCI bits for multiplexing so that effective coding rates of the multiplexed HP UCI and LP UCI bits are not larger than corresponding maxCodeRate values. For example, a part of HP CSI reports (e.g., CSI-part1 reports of lower CSI report priority values, CSI-part2 reports) may be dropped (e.g., not included in O_{HP UCI} bits). LP HARQ-ACK/LP SR may be bundled (or compressed) and/or a certain type of LP UCI (e.g., LP SR associated with lower logical channel priority values) may be completely dropped (e.g., not included in O_{LP UCI} bits).

In another implementation, the UE determines O_{HP UCI} bits and O_{LP UCI} bits by including all types of UCI bits that are allowed for multiplexing. If the determined O_{HP UCI} bits and O_{LP UCI} bits satisfy the following equation (e.g., the total number of channel bits based on the determined HP and LP UCI payload sizes and given maxCodeRate values of HP UCI and LP UCI is larger than the channel bit size that can be accommodated by the configured max number of PRBs), the UE transmits the PUCCH over the configured maximum number of PRBs N_{PRB}^{PUCCH} where: [(O_{HP UCI}+O_{HP,CRC})/R_{HP UCI}^{max}/Qₘ]+[O_{LP UCI}+O_{LP,CRC})/R_{LP UCI}^{max}/Qₘ]>N_{PRB}^{PUCCH}·N_{sc,ctrl}^{RB}·N_{symb, UCI}^{PUCCH}.

In a further implementation, if the UE employs separate coding of LP UCI and HP UCI to transmit the LP UCI and HP UCI in the PUCCH resource, the UE performs rate-matching for coded LP and HP UCI bits, which results in rate-matching output sequences with respective lengths shown in Table 3. In some implementations, LP UCI and HP CSI-part2 may be jointly encoded.

TABLE 3
Rate matching output sequence length E_{UCI}

| UCI(s) for | | |
|---|---|---|
| transmission on a | UCI for | |
| PUCCH | encoding | Value of E_{UCI} |
| LP UCI and HP | LP UCI (e.g. LP | E_{UCI} = Eₜₒₜ − min(Eₜₒₜ, ┌(O_{HP UCI} + O_{HP, CRC})/R_{HP UCI}^{max}/ |
| UCI | HARQ-ACK | Qₘ┐ · Qₘ) |
| | and/or LP SR) | |
| | HP UCI (e.g. | E_{UCI} = min(Eₜₒₜ, ┌(O_{HP UCI} + O_{HP,CRC})/R_{HP UCI}^{max}/ |
| | HP HARQ- | Qₘ┐ · Qₘ) |
| | ACK, HP SR, | |
| | and/or HP CSI) | |

For PUCCH formats 2/3/4, the total rate matching output sequence length Eₜₒₜ is given (e.g., Table 4), where N_{symb,UCI}^{PUCCH,2}, N_{symb,UCI}^{PUCCH,3} and N_{symb,UCI}^{PUCCH,4} are the number of symbols carrying UCI for PUCCH formats 2/3/4 respectively: N_{PRB}^{PUCCH,2} and N_{PRB}^{PUCCH,3} are the number of PRBs that are determined by the UE for PUCCH formats 2/3 transmission respectively; and N_{SF}^{PUCCH,2}, N_{SF}^{PUCCH,3}, and N_{SF}^{PUCCH,4} are the spreading factors for PUCCH format 2, PUCCH format 3, and PUCCH format 4, respectively.

TABLE 4
Total rate matching output sequence length Eₜₒₜ

| PUCCH | Modulation order | |
|---|---|---|
| format | QPSK | π/2-BPSK |
| PUCCH | 16 · N_{symb, UCI}^{PUCCH,2} · N_{PRB}^{PUCCH,2}/ | N/A |
| format 2 | N_{SF}^{PUCCH,2} | |
| PUCCH | 24 · N_{symb, UCI}^{PUCCH,3} · N_{PRB}^{PUCCH,3}/ | 12 · N_{symb, UCI}^{PUCCH,3} · N_{PRB}^{PUCCH,3}/ |
| format 3 | N_{SF}^{PUCCH,3} | N_{SF}^{PUCCH,3} |
| PUCCH | 24 · N_{symb, UCI}^{PUCCH,4}/N_{SF}^{PUCCH,4} | 12 · N_{symb, UCI}^{PUCCH,4}/N_{SF}^{PUCCH,4} |
| format 4 | | |

In one embodiment, if a UE transmits HP UCI and LP UCI in a PUCCH with PUCCH format 2, the UE multiplexes separately coded and rate-matched HP UCI channel bits and LP UCI channel bits.

In certain methods, the HP UCI channel bits are mapped to available REs of PUCCH, starting from the earliest PUCCH symbol in a frequency-first manner (e.g., in increasing order of first the subcarrier index over the assigned physical resource blocks and then the PUCCH symbol index), with occupying [(O_{HP UCI}+O_{HP,CRC})/R_{HP UCI}^{max}/Qₘ] REs.

In various methods, the HP UCI channel bits are mapped to the first N_{HP-RB}^{PUCCH} RBs of the PUCCH, and the LP UCI channel bits are mapped to the remaining N_{LP-RB}^{PUCCH} RBs of the PUCCH, The N_{HP-RB}^{PUCCH} PUCCH RBs and NLP-RB RBs may be further interleaved over (N_{HP-RB}^{PUCCH}+N_{LP-RB}^{PUCCH}) PRBs to exploit frequency-domain channel diversity.

In one implementation, if a UE transmits HP UCI and LP UCI in a PUCCH with PUCCH format 3 or PUCCH format 4, the UE multiplexes separately coded and rate-matched HP UCI channel bits and LP UCI channel bits such that the HP UCI channel bits are mapped to PUCCH symbols of first (J−1) PUCCH symbol sets in a frequency-first manner (e.g., in increasing order of first the subcarrier index over assigned physical resource blocks and then the PUCCH symbol index) and then mapped to PUCCH symbols of J-th PUCCH symbol set in a frequency-first manner over a subset of subcarriers of the assigned physical resource blocks, with occupying [(O_{HP UCI}+O_{HP,CRC})/R_{HP UCI}^{max}/Qₘ] REs or (N_{HP-RB}^{PUCCH}·N_{sc,ctrl}^{RB}·N_{symb,UCI}^{PUCCH}·R_{HP UCI}^{max}) REs. The LP UCI channel bits are mapped to the remaining REs in a frequency first manner.

In one example, if LP UCI and HP UCI are transmitted on a PUCCH, the coded bits corresponding to HP UCI bit sequence a₀⁽¹⁾, a₁⁽¹⁾, a₃⁽¹⁾, . . . , a_{A(1)-1}⁽¹⁾ is denoted by g₀⁽¹⁾, g₁⁽¹⁾, g₂⁽¹⁾, g₃⁽¹⁾, . . . ,g_{G(1)-1}⁽¹⁾ and the coded bits corresponding to LP UCI bit sequence a₀⁽²⁾, a₁⁽²⁾, a₂⁽²⁾,a₃⁽²⁾, . . . ,a_{A(2)-1}⁽²⁾ is denoted by g₀⁽²⁾, g₁⁽²⁾, g₂⁽²⁾, g₃⁽²⁾, . . . , g_{G(2)-1}⁽²⁾. The coded bit sequence g₀, g₁, g₂, g₃, . . . , g_{G-1}, where G=G⁽¹⁾+G⁽²⁾, is generated according to the following.

Denote sₗ as UCI OFDM symbol index. Denote N_{UCI}⁽ⁱ⁾ as the number of elements in UCI symbol indices set S_{UCI}⁽ⁱ⁾ for i=1, . . . , N_{UCI}^{set}, where S_{UCI}⁽ⁱ⁾ and N_{UCI}^{set} are given according to the PUCCH duration and the PUCCH demodulation reference signal (“DMRS” or “DM-RS”) configuration. Denote

$${N}_{symb , UCI}^{PUCCH} = {\sum }_{i = 1}^{{N}_{UCI}^{set}} {N}_{UCI}^{( i )}$$

as the number of OFDM symbols carrying UCI in the PUCCH.

For PUCCH format 3, set N_{UCI}^{symbol}=12·N_{PRB}^{PUCCH,3}/N_{SF}^{PUCCH,3}, where N_{PRB}^{PUCCH,3} is the number of PRBs that is determined by the UE for PUCCH format 3 transmission, and N_{SF}^{PUCCH,3} is the spreading factor for PUCCH format 3. For PUCCH format 4, set N_{UCI}^{symbol}=12/N_{SF}^{PUCCH,4}, where N_{SF}^{PUCCH,4} is the spreading factor for PUCCH format 4.

Find the smallest j>0 such that

$$( {\sum }_{i = 1}^{j} {N}_{U C I}^{( i )} ) \cdot {N}_{UCI}^{symbol} \cdot {Q}_{m} \geq {G}^{( 1 )} .$$

Set n₁=0; Set m₂=0; Set

$${\overline{N}}_{UCI}^{symbol} = ⌊ ( {G}^{( 1 )} - ( {\sum }_{i = 1}^{j - 1} {N}_{UCI}^{( i )} ) \cdot {N}_{UCI}^{symbo1} \cdot {Q}_{m} ) / ( {N}_{UCI}^{( j )} \cdot {Q}_{m} ) ⌋ ;$$

### Set

$$M = mod ( ( {G}^{〈 1 )} - ( {\sum }_{i = 1}^{j - 1} {N}_{UCI}^{〈 i )} ) \cdot {N}_{UCI}^{symbol} \cdot {Q}_{m} ) / {Q}_{m} , {N}_{UCI}^{〈 / )} ) ;$$

for I=0 to N_{symb,UCI}^{PUCCH}−1, if

$${s}_{l} ∈ {⋃}_{i = 1}^{j - 1} {S}_{UCI}^{( i )} ,$$

for k=0 to N_{UCI}^{symbol}−1, for v=0 to Qₘ−1 g_{1,k,v}=gₙ_{₁}⁽¹⁾; n₁=n₁+1; end for, end for;

elseif Sₗ∈S_{UCI}^{(j)}, if M>0 γ=1; else γ=0; end if M=M−1; for k=0 to N_{UCI}^{symbol}+γ−1, for v=0 to Qₘ−1 g_{l,k,v}=gₙ_{₁}^{(l)}; n₁=n₁+1; end for, end for;

for k=N_{UCI}^{symbol}+γ to N_{UCI}^{symbol}−1, for v=0 to Qₘ−1 g_{l,k,v}=hₙ_{₂}⁽²⁾; n₂=n₂+1: end for, symbol end for, else for k=0 to N_{UCI}^{symbol}−1, for v=0 to Qₘ−1 g_{l,k,v}=gₙ_{₂}⁽²⁾; n₂=n₂+1: end for, end for, end if, end for:

Set n=0, for I=0 to N_{symb,UCI}^{PUCCH,}−1, for k=0 to N_{UCI}^{symbol}−1, for v=0 to Qₘ−1 gₙ=g_{l,k,v}; n=n+1: end for, end for, end for.

In a third embodiment, there may be multiplexing of CSI in a PUSCH carrying UCI of mixed priorities. In one embodiment, if a UE would transmit HP UCI and LP UCI in overlapping (e.g., in time domain) PUCCHs, respectively, and if a PUCCH resource determined to multiplex at least a part of HP UCI and at least a part of LP UCI overlaps in time with one or more PUSCHs, the UE multiplexes the HP UCI and the LP UCI into a PUSCH of the one or more PUSCHs. If the one or more PUSCHs comprise at least one HP PUSCH (e.g., a PUSCH of a higher physical layer priority index), the PUSCH is selected from the at least one HP PUSCH, where the selected PUSCH may include aperiodic CSI. If the one or more PUSCHs comprise only one or more LP PUSCHs (e.g., PUSCHs of a lower physical layer priority index), the PUSCH is selected from the one or more LP PUSCHs, where the selected PUSCH may include aperiodic CSI.

In an implementation, if the UE would transmit UL shared channel (“SCH”) (“UL-SCH”) on the selected PUSCH of a given physical layer priority, the UE does not multiplex SR of the given physical layer priority from the HP UCI or LP UCI into the PUSCH of the given physical layer priority but multiplexes SR of a physical layer priority different than the given physical layer priority into the PUSCH. In one example, the UE jointly encodes SR and HARQ-ACK of the same physical layer priority. In another example, the UE jointly encodes SR, HARQ-ACK, and CG-UCI of the same physical layer priority.

In another implementation, if the HP UCI includes first HP CSI and if the selected PUSCH is a HP PUSCH with second HP CSI (e.g., semi-persistent or aperiodic CSI), the UE does not transmit the first HP CSI but transmits the second HP CSI in the PUSCH, when the first HP CSI includes NR periodic or semi-persistent CSI reports; and the UE multiplexes enhanced CSI (e.g., CSI statistics, updated CQI) of the first HP CSI and the second HP CSI (e.g., semi-persistent or aperiodic CSI) into the PUSCH, if the first HP CSI includes the enhanced CSI. Multiplexing of the enhanced CSI (e.g., of PUCCH) with the semi-persistent/aperiodic CSI (e.g., of PUSCH) may be enabled or disabled by a network entity via RRC configuration and/or MAC CE/DCI signaling. In an example, the UE jointly encodes the enhanced CSI and the semi-persistent/aperiodic CSI.

In a further implementation, if the HP UCI includes HP CSI and if the selected PUSCH is a LP PUSCH with aperiodic CSI, the UE multiplexes the HP CSI in the PUSCH, and does not transmit the aperiodic CSI.

In some implementations, the UE multiplexes the HP CSI and the aperiodic CSI into the PUSCH.

In another implementation, if the HP UCI includes HP CSI and if the selected PUSCH is a LP PUSCH with semi-persistent CSI, the UE multiplexes the HP CSI in the PUSCH, and does not transmit the semi-persistent CSI.

In various implementations, if the LP UCI includes LP CSI, and if the selected PUSCH is a HP PUSCH with HP CSI (e.g., semi-persistent or aperiodic CSI), the UE does not transmit the LP CSI but transmits the HP CSI in the PUSCH.

If a UE multiplexes HP UCI (e.g., HP HARQ-ACK, SR, CSI, and/or CG-UCI) and LP UCI (e.g., LP HARQ-ACK, SR, CSI, and/or CG-UCI) in a PUSCH.

In some methods, the UE performs first encoding jointly with HP HARQ-ACK/SR/CG-UCI, second encoding jointly with LP HARQ-ACK/SR/CG-UCI, and third encoding jointly with HP CSI/LP CSI.

In various methods, the UE performs first encoding jointly with HP HARQ-ACK/SR/CG-UCI, second encoding jointly with LP HARQ-ACK/SR/CG-UCI/HP CSI-part1, and third encoding jointly with HP CSI-part2/LP CSI.

In certain methods, the UE performs first encoding jointly with HP HARQ-ACK/SR/CG-UCI/HP CSI-part1, second encoding jointly with LP HARQ-ACK/SR/CG-UCI/HP CSI-part2, and third encoding jointly with LP CSI, if LP CSI is multiplexed. Otherwise, the UE performs first encoding jointly with HP HARQ-ACK/SR/CG-UCI, second encoding with HP CSI-part1, and third encoding jointly with LP HARQ-ACK/SR/CG-UCI/HP CSI-part2.

The UE performs rate-matching of coded bits according to the resource allocation priority order of 1st priority for first bits from the first encoding, 2nd priority for second bits from the second encoding, and 3rd priority for third bits from the third encoding.

If a UE transmits multiple PUSCHs in a slot (or a sub-slot) on respective serving cells and the UE would multiplex UCI in one of the multiple PUSCHs and the UE does not multiplex aperiodic CSI in any of the multiple PUSCHs, the UE multiplexes the UCI in a PUSCH of the serving cell with the smallest ServCellIndex subject to conditions for UCI multiplexing being fulfilled. If the UE transmits more than one PUSCHs in the slot on the serving cell with the smallest ServCellIndex that fulfil conditions for UCI multiplexing, the UE multiplexes the UCI in the earliest PUSCH that the UE transmits in the slot.

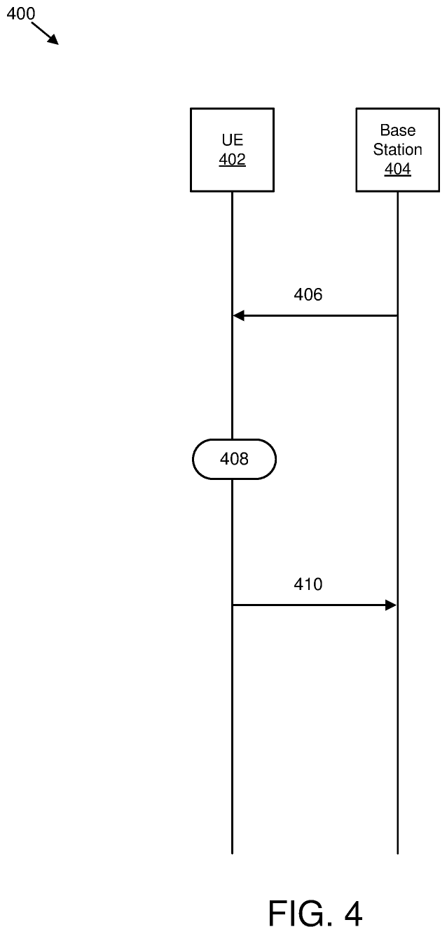

FIG. 4 is a schematic block diagram illustrating one embodiment of a system 400 for determining a number of PRBs for a PUCCH transmission. The system 400 includes a UE 402 and a base station 404. It should be noted that each communication in the system 400 may include one or more messages. In a first communication 406, the base station 404 transmits information indicating a first code rate and a second code rate to the UE 402. The first code rate is associated with multiplexed HP UCI bits and the second code rate is associated with multiplexed LP UCI bits. The UE 402 determines 408 a number of PRBs for a PUCCH transmission based at least on the first code rate, a number of multiplexed HP UCI bits, the second code rate, a number of multiplexed LP UCI bits, and a maximum number of PRBs for the PUCCH transmission. In a second communication 410, the UE 402 transmits the PUCCH transmission in the number of PRBs to the base station 404.

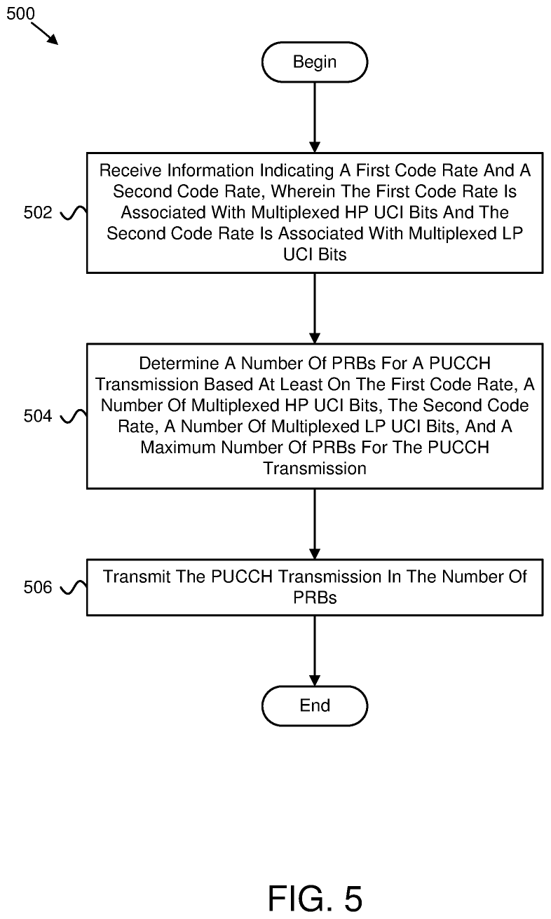

FIG. 5 is a flow chart diagram illustrating one embodiment of a method 500 for determining a number of PRBs for a PUCCH transmission. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502 information indicating a first code rate and a second code rate. The first code rate is associated with multiplexed HP UCI bits and the second code rate is associated with multiplexed LP UCI bits. In some embodiments, the method 500 includes determining 504 a number of PRBs for a PUCCH transmission based at least on the first code rate, a number of multiplexed HP UCI bits, the second code rate, a number of multiplexed LP UCI bits, and a maximum number of PRBs for the PUCCH transmission. In certain embodiments, the method 500 includes transmitting 506 the PUCCH transmission in the number of PRBs.

In certain embodiments, the method 500 further comprises receiving information indicating the maximum number of PRBs for the PUCCH transmission. In some embodiments: the number of PRBs for the PUCCH transmission is determined as a minimum number of PRBs that provides a total number of REs required for multiplexing the HP UCI bits and the LP UCI bits in response to the total number of REs required for multiplexing the HP UCI bits and the LP UCI bits not being greater than a number of REs provided by the maximum number of PRBs for the PUCCH transmission; and the number of PRBs for the PUCCH transmission is the same as the maximum number of PRBs for the PUCCH transmission in response to the total number of REs required for multiplexing the HP UCI bits and the LP UCI bits being greater than a number of REs provided by the maximum number of PRBs for the PUCCH transmission.

In various embodiments, the total number of REs required for multiplexing the HP UCI bits and the LP UCI bits is determined based on the first code rate, the number of multiplexed HP UCI bits, the second code rate, the number of multiplexed LP UCI bits, and a modulation scheme for the PUCCH transmission. In one embodiment, the method 500 further comprises: determining the number of the multiplexed HP UCI bits, wherein the multiplexed HP UCI bits comprise at least HP HARQ-ACK information bits; and determining the number of the multiplexed LP UCI bits, wherein the multiplexed LP UCI bits comprise LP HARQ-ACK information bits. In certain embodiments, the multiplexed HP UCI bits further comprise HP UCI CRC bits, HP SR bits, or a combination thereof.

In some embodiments, the multiplexed LP UCI bits further comprise LP UCI CRC bits. In various embodiments, the method 500 further comprises: performing encoding of the multiplexed HP UCI bits to generate first coded bits: performing encoding of the multiplexed LP UCI bits to generate second coded bits: performing rate matching of the first coded bits to generate a first rate matching output sequence; and performing rate matching of the second coded bits to generate a second rate matching output sequence, wherein the PUCCH transmission comprises the first rate matching output sequence and the second rate matching output sequence.

In one embodiment, the method 500 further comprises: determining a total rate matching output sequence length at least based on the number of PRBs for the PUCCH transmission; and determining a first length of the first rate matching output sequence based on the total rate matching output sequence length, the number of the multiplexed HP UCI bits, the first code rate, and a modulation scheme for the PUCCH transmission, wherein the first rate matching output sequence is generated based on the first length. In certain embodiments, the method 500 further comprises determining a second length of the second rate matching output sequence based on the total rate matching output sequence length and the first length, wherein the second rate matching output sequence is generated based on the second length.

In some embodiments, the PUCCH transmission comprises the first rate matching output sequence concatenated with the second rate matching output sequence. In various embodiments, the first rate matching output sequence is transmitted no later than the second rate matching output sequence.

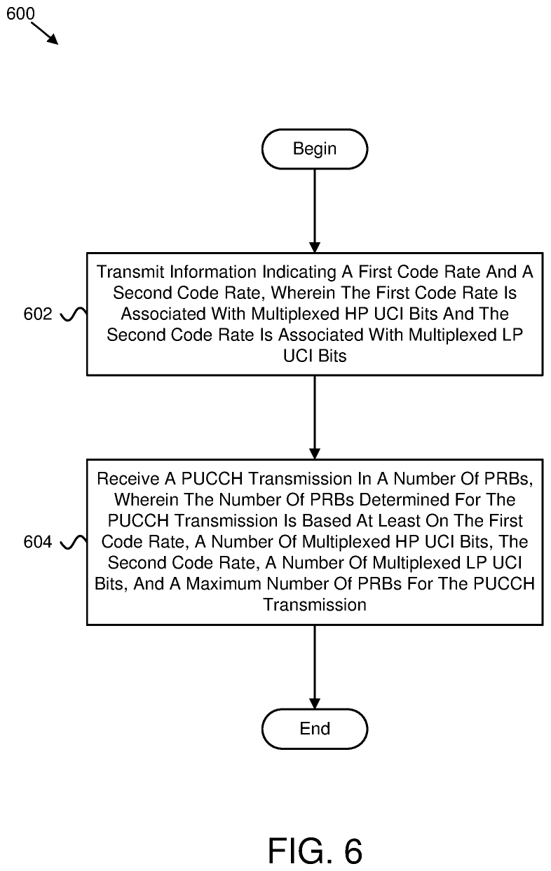

FIG. 6 is a flow chart diagram illustrating another embodiment of a method 600 for determining a number of PRBs for a PUCCH transmission. In some embodiments, the method 600 is performed by an apparatus, such as the network unit 104. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes transmitting 602 information indicating a first code rate and a second code rate. The first code rate is associated with multiplexed HP UCI bits and the second code rate is associated with multiplexed LP UCI bits. In some embodiments, the method 600 includes receiving 604 a PUCCH transmission in a number of PRBs. The number of PRBs determined for the PUCCH transmission is based at least on the first code rate, a number of multiplexed HP UCI bits, the second code rate, a number of multiplexed LP UCI bits, and a maximum number of PRBs for the PUCCH transmission.

In certain embodiments, the method 600 further comprises transmitting information indicating the maximum number of PRBs for the PUCCH transmission. In some embodiments: the number of PRBs for the PUCCH transmission is determined as a minimum number of PRBs that provides a total number of REs required for multiplexing the HP UCI bits and the LP UCI bits in response to the total number of REs required for multiplexing the HP UCI bits and the LP UCI bits not being greater than a number of REs provided by the maximum number of PRBs for the PUCCH transmission; and the number of PRBs for the PUCCH transmission is the same as the maximum number of PRBs for the PUCCH transmission in response to the total number of REs required for multiplexing the HP UCI bits and the LP UCI bits being greater than a number of REs provided by the maximum number of PRBs for the PUCCH transmission. In various embodiments, the total number of REs required for multiplexing the HP UCI bits and the LP UCI bits is determined based on the first code rate, the number of multiplexed HP UCI bits, the second code rate, the number of multiplexed LP UCI bits, and a modulation scheme for the PUCCH transmission.

In one embodiment, an apparatus comprises: a receiver to receive information indicating a first code rate and a second code rate, wherein the first code rate is associated with multiplexed HP UCI bits and the second code rate is associated with multiplexed LP UCI bits: a processor to determine a number of PRBs for a PUCCH transmission based at least on the first code rate, a number of multiplexed HP UCI bits, the second code rate, a number of multiplexed LP UCI bits, and a maximum number of PRBs for the PUCCH transmission; and a transmitter to transmit the PUCCH transmission in the number of PRBs.

In certain embodiments, the receiver further to receive information indicating the maximum number of PRBs for the PUCCH transmission.

In some embodiments: the number of PRBs for the PUCCH transmission is determined as a minimum number of PRBs that provides a total number of REs required for multiplexing the HP UCI bits and the LP UCI bits in response to the total number of REs required for multiplexing the HP UCI bits and the LP UCI bits not being greater than a number of REs provided by the maximum number of PRBs for the PUCCH transmission; and the number of PRBs for the PUCCH transmission is the same as the maximum number of PRBs for the PUCCH transmission in response to the total number of REs required for multiplexing the HP UCI bits and the LP UCI bits being greater than a number of REs provided by the maximum number of PRBs for the PUCCH transmission.

In various embodiments, the total number of REs required for multiplexing the HP UCI bits and the LP UCI bits is determined based on the first code rate, the number of multiplexed HP UCI bits, the second code rate, the number of multiplexed LP UCI bits, and a modulation scheme for the PUCCH transmission.

In one embodiment, the processor further to: determine the number of the multiplexed HP UCI bits, wherein the multiplexed HP UCI bits comprise at least HP HARQ-ACK information bits; and determine the number of the multiplexed LP UCI bits, wherein the multiplexed LP UCI bits comprise LP HARQ-ACK information bits.

In certain embodiments, the multiplexed HP UCI bits further comprise HP UCI CRC bits, HP SR bits, or a combination thereof.

In some embodiments, the multiplexed LP UCI bits further comprise LP UCI CRC bits.

In various embodiments, the processor further to: perform encoding of the multiplexed HP UCI bits to generate first coded bits: perform encoding of the multiplexed LP UCI bits to generate second coded bits: perform rate matching of the first coded bits to generate a first rate matching output sequence; and perform rate matching of the second coded bits to generate a second rate matching output sequence, wherein the PUCCH transmission comprises the first rate matching output sequence and the second rate matching output sequence.

In one embodiment, the processor further to: determine a total rate matching output sequence length at least based on the number of PRBs for the PUCCH transmission; and determine a first length of the first rate matching output sequence based on the total rate matching output sequence length, the number of the multiplexed HP UCI bits, the first code rate, and a modulation scheme for the PUCCH transmission, wherein the first rate matching output sequence is generated based on the first length.

In certain embodiments, the processor further to determine a second length of the second rate matching output sequence based on the total rate matching output sequence length and the first length, and the second rate matching output sequence is generated based on the second length.

In some embodiments, the PUCCH transmission comprises the first rate matching output sequence concatenated with the second rate matching output sequence.

In various embodiments, the first rate matching output sequence is transmitted no later than the second rate matching output sequence.

In one embodiment, a method in a user equipment comprises: receiving information indicating a first code rate and a second code rate, wherein the first code rate is associated with multiplexed HP UCI bits and the second code rate is associated with multiplexed LP UCI bits: determining a number of PRBs for a PUCCH transmission based at least on the first code rate, a number of multiplexed HP UCI bits, the second code rate, a number of multiplexed LP UCI bits, and a maximum number of PRBs for the PUCCH transmission; and transmitting the PUCCH transmission in the number of PRBs.

In certain embodiments, the method further comprises receiving information indicating the maximum number of PRBs for the PUCCH transmission.

In some embodiments: the number of PRBs for the PUCCH transmission is determined as a minimum number of PRBs that provides a total number of REs required for multiplexing the HP UCI bits and the LP UCI bits in response to the total number of REs required for multiplexing the HP UCI bits and the LP UCI bits not being greater than a number of REs provided by the maximum number of PRBs for the PUCCH transmission; and the number of PRBs for the PUCCH transmission is the same as the maximum number of PRBs for the PUCCH transmission in response to the total number of REs required for multiplexing the HP UCI bits and the LP UCI bits being greater than a number of REs provided by the maximum number of PRBs for the PUCCH transmission.

In various embodiments, the total number of REs required for multiplexing the HP UCI bits and the LP UCI bits is determined based on the first code rate, the number of multiplexed HP UCI bits, the second code rate, the number of multiplexed LP UCI bits, and a modulation scheme for the PUCCH transmission.

In one embodiment, the method further comprises: determining the number of the multiplexed HP UCI bits, wherein the multiplexed HP UCI bits comprise at least HP HARQ-ACK information bits; and determining the number of the multiplexed LP UCI bits, wherein the multiplexed LP UCI bits comprise LP HARQ-ACK information bits.

In certain embodiments, the multiplexed HP UCI bits further comprise HP UCI CRC bits, HP SR bits, or a combination thereof.

In some embodiments, the multiplexed LP UCI bits further comprise LP UCI CRC bits.

In various embodiments, the method further comprises: performing encoding of the multiplexed HP UCI bits to generate first coded bits: performing encoding of the multiplexed LP UCI bits to generate second coded bits: performing rate matching of the first coded bits to generate a first rate matching output sequence; and performing rate matching of the second coded bits to generate a second rate matching output sequence, wherein the PUCCH transmission comprises the first rate matching output sequence and the second rate matching output sequence.

In one embodiment, the method further comprises: determining a total rate matching output sequence length at least based on the number of PRBs for the PUCCH transmission; and determining a first length of the first rate matching output sequence based on the total rate matching output sequence length, the number of the multiplexed HP UCI bits, the first code rate, and a modulation scheme for the PUCCH transmission, wherein the first rate matching output sequence is generated based on the first length.

In certain embodiments, the method further comprises determining a second length of the second rate matching output sequence based on the total rate matching output sequence length and the first length, wherein the second rate matching output sequence is generated based on the second length.

In some embodiments, the PUCCH transmission comprises the first rate matching output sequence concatenated with the second rate matching output sequence.

In various embodiments, the first rate matching output sequence is transmitted no later than the second rate matching output sequence.

In one embodiment, an apparatus comprises: a transmitter to transmit information indicating a first code rate and a second code rate, wherein the first code rate is associated with multiplexed HP UCI bits and the second code rate is associated with multiplexed LP UCI bits; and a receiver to receive a PUCCH transmission in a number of PRBs, wherein the number of PRBs determined for the PUCCH transmission is based at least on the first code rate, a number of multiplexed HP UCI bits, the second code rate, a number of multiplexed LP UCI bits, and a maximum number of PRBs for the PUCCH transmission.

In certain embodiments, the transmitter further to transmit information indicating the maximum number of PRBs for the PUCCH transmission.

In some embodiments: the number of PRBs for the PUCCH transmission is determined as a minimum number of PRBs that provides a total number of REs required for multiplexing the HP UCI bits and the LP UCI bits in response to the total number of REs required for multiplexing the HP UCI bits and the LP UCI bits not being greater than a number of REs provided by the maximum number of PRBs for the PUCCH transmission; and the number of PRBs for the PUCCH transmission is the same as the maximum number of PRBs for the PUCCH transmission in response to the total number of REs required for multiplexing the HP UCI bits and the LP UCI bits being greater than a number of REs provided by the maximum number of PRBs for the PUCCH transmission.

In various embodiments, the total number of REs required for multiplexing the HP UCI bits and the LP UCI bits is determined based on the first code rate, the number of multiplexed HP UCI bits, the second code rate, the number of multiplexed LP UCI bits, and a modulation scheme for the PUCCH transmission.

In one embodiment, a method in a network device comprises: transmitting information indicating a first code rate and a second code rate, wherein the first code rate is associated with multiplexed HP UCI bits and the second code rate is associated with multiplexed LP UCI bits; and receiving a PUCCH transmission in a number of PRBs, wherein the number of PRBs determined for the PUCCH transmission is based at least on the first code rate, a number of multiplexed HP UCI bits, the second code rate, a number of multiplexed LP UCI bits, and a maximum number of PRBs for the PUCCH transmission.

In certain embodiments, the method further comprises transmitting information indicating the maximum number of PRBs for the PUCCH transmission.

In some embodiments: the number of PRBs for the PUCCH transmission is determined as a minimum number of PRBs that provides a total number of REs required for multiplexing the HP UCI bits and the LP UCI bits in response to the total number of REs required for multiplexing the HP UCI bits and the LP UCI bits not being greater than a number of REs provided by the maximum number of PRBs for the PUCCH transmission; and the number of PRBs for the PUCCH transmission is the same as the maximum number of PRBs for the PUCCH transmission in response to the total number of REs required for multiplexing the HP UCI bits and the LP UCI bits being greater than a number of REs provided by the maximum number of PRBs for the PUCCH transmission.

In various embodiments, the total number of REs required for multiplexing the HP UCI bits and the LP UCI bits is determined based on the first code rate, the number of multiplexed HP UCI bits, the second code rate, the number of multiplexed LP UCI bits, and a modulation scheme for the PUCCH transmission.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive information indicating a first code rate and a second code rate, wherein the first code rate is associated with multiplexed high priority (HP) uplink control information (UCI) bits and the second code rate is associated with multiplexed low priority (LP) UCI bits;
determine a number of physical resource blocks (PRBs) for a physical uplink control channel (PUCCH) transmission based at least on the first code rate, a number of multiplexed HP UCI bits, the second code rate, a number of multiplexed LP UCI bits, and a maximum number of PRBs for the PUCCH transmission; and
transmit the PUCCH transmission in the number of PRBs.

2. The UE of claim 1, wherein the at least one processor is configured to cause the UE to receive information indicating the maximum number of PRBs for the PUCCH transmission.

3. The UE of claim 1, wherein:
the number of PRBs for the PUCCH transmission is determined as a minimum number of PRBs that provides a total number of resource elements (REs) required for multiplexing the HP UCI bits and the LP UCI bits in response to the total number of REs required for multiplexing the HP UCI bits and the LP UCI bits not being greater than a number of REs provided by the maximum number of PRBs for the PUCCH transmission; and
the number of PRBs for the PUCCH transmission is the same as the maximum number of PRBs for the PUCCH transmission in response to the total number of REs required for multiplexing the HP UCI bits and the LP UCI bits being greater than a number of REs provided by the maximum number of PRBs for the PUCCH transmission.

4. The UE of claim 3, wherein the total number of resource elements (REs) required for multiplexing the HP UCI bits and the LP UCI bits is determined based on the first code rate, the number of multiplexed HP UCI bits, the second code rate, the number of multiplexed LP UCI bits, and a modulation scheme for the PUCCH transmission.

5. The UE of claim 1, wherein the at least one processor is configured to cause the UE to:
determine the number of the multiplexed HP UCI bits, wherein the multiplexed HP UCI bits comprise at least HP hybrid automatic repeat request-acknowledgement (HARQ-ACK) information bits; and
determine the number of the multiplexed LP UCI bits, wherein the multiplexed LP UCI bits comprise LP HARQ-ACK information bits.

6. The UE of claim 5, wherein the multiplexed HP UCI bits further comprise HP UCI cyclic redundancy check (CRC) bits, HP scheduling request (SR) bits, or a combination thereof.

7. The UE of claim 5, wherein the multiplexed LP UCI bits further comprise LP UCI cyclic redundancy check (CRC) bits.

8. The UE of claim 1, wherein the at least one processor is configured to cause the UE to:
perform encoding of the multiplexed HP UCI bits to generate first coded bits;
perform encoding of the multiplexed LP UCI bits to generate second coded bits;
perform rate matching of the first coded bits to generate a first rate matching output sequence; and
perform rate matching of the second coded bits to generate a second rate matching output sequence, wherein the PUCCH transmission comprises the first rate matching output sequence and the second rate matching output sequence.

9. The UE of claim 8, wherein the at least one processor is configured to cause the UE to:
determine a total rate matching output sequence length at least based on the number of PRBs for the PUCCH transmission; and
determine a first length of the first rate matching output sequence based on the total rate matching output sequence length, the number of the multiplexed HP UCI bits, the first code rate, and a modulation scheme for the PUCCH transmission, wherein the first rate matching output sequence is generated based on the first length.

10. The UE of claim 9, wherein the at least one processor is configured to cause the UE to determine a second length of the second rate matching output sequence based on the total rate matching output sequence length and the first length, and the second rate matching output sequence is generated based on the second length.

11. The UE of claim 8, wherein the PUCCH transmission comprises the first rate matching output sequence concatenated with the second rate matching output sequence.

12. The UE of claim 8, wherein the first rate matching output sequence is transmitted no later than the second rate matching output sequence.

13. A method performed by a user equipment (UE), the method comprising:
receiving information indicating a first code rate and a second code rate, wherein the first code rate is associated with multiplexed high priority (HP) uplink control information (UCI) bits and the second code rate is associated with multiplexed low priority (LP) UCI bits;
determining a number of physical resource blocks (PRBs) for a physical uplink control channel (PUCCH) transmission based at least on the first code rate, a number of multiplexed HP UCI bits, the second code rate, a number of multiplexed LP UCI bits, and a maximum number of PRBs for the PUCCH transmission; and
transmitting the PUCCH transmission in the number of PRBs.

14. A base station, comprising:
at least one memory; and
at least one processor coupled with the at least one memory and configured to cause the base station to:
transmit information indicating a first code rate and a second code rate, wherein the first code rate is associated with multiplexed high priority (HP) uplink control information (UCI) bits and the second code rate is associated with multiplexed low priority (LP) UCI bits; and
receive a physical uplink control channel (PUCCH) transmission in a number of physical resource blocks (PRBs), wherein the number of PRBs determined for the PUCCH transmission is based at least on the first code rate, a number of multiplexed HP UCI bits, the second code rate, a number of multiplexed LP UCI bits, and a maximum number of PRBs for the PUCCH transmission.

15. The base station of claim 14, wherein:
the number of PRBs for the PUCCH transmission is determined as a minimum number of PRBs that provides a total number of resource elements (REs) required for multiplexing the HP UCI bits and the LP UCI bits in response to the total number of REs required for multiplexing the HP UCI bits and the LP UCI bits not being greater than a number of REs provided by the maximum number of PRBs for the PUCCH transmission; and
the number of PRBs for the PUCCH transmission is the same as the maximum number of PRBs for the PUCCH transmission in response to the total number of REs required for multiplexing the HP UCI bits and the LP UCI bits being greater than a number of REs provided by the maximum number of PRBs for the PUCCH transmission.

16. A processor for wireless communication, comprising:
at least one controller coupled with at least one memory and configured to cause the processor to:
receive information indicating a first code rate and a second code rate, wherein the first code rate is associated with multiplexed high priority (HP) uplink control information (UCI) bits and the second code rate is associated with multiplexed low priority (LP) UCI bits;
determine a number of physical resource blocks (PRBs) for a physical uplink control channel (PUCCH) transmission based at least on the first code rate, a number of multiplexed HP UCI bits, the second code rate, a number of multiplexed LP UCI bits, and a maximum number of PRBs for the PUCCH transmission; and
transmit the PUCCH transmission in the number of PRBs.

17. The processor of claim 16, wherein the at least one controller is configured to cause the processor to receive information indicating the maximum number of PRBs for the PUCCH transmission.

18. The processor of claim 16, wherein:
the number of PRBs for the PUCCH transmission is determined as a minimum number of PRBs that provides a total number of resource elements (REs) required for multiplexing the HP UCI bits and the LP UCI bits in response to the total number of REs required for multiplexing the HP UCI bits and the LP UCI bits not being greater than a number of REs provided by the maximum number of PRBs for the PUCCH transmission; and
the number of PRBs for the PUCCH transmission is the same as the maximum number of PRBs for the PUCCH transmission in response to the total number of REs required for multiplexing the HP UCI bits and the LP UCI bits being greater than a number of REs provided by the maximum number of PRBs for the PUCCH transmission.

19. The processor of claim 18, wherein the total number of resource elements (REs) required for multiplexing the HP UCI bits and the LP UCI bits is determined based on the first code rate, the number of multiplexed HP UCI bits, the second code rate, the number of multiplexed LP UCI bits, and a modulation scheme for the PUCCH transmission.

20. The processor of claim 16, wherein the at least one controller is configured to cause the processor to:
determine the number of the multiplexed HP UCI bits, wherein the multiplexed HP UCI bits comprise at least HP hybrid automatic repeat request-acknowledgement (HARQ-ACK) information bits; and
determine the number of the multiplexed LP UCI bits, wherein the multiplexed LP UCI bits comprise LP HARQ-ACK information bits.
